(19) United States
(12) Patent Application Publication
(10) Pub. No.: US 2005/0052956 A1
(43) Pub. Date: Mar. 10, 2005

(54) Method for determining reproducing light beam intensity and recording and reproducing apparatus

(75) Inventors: Hiroshi Ido, Moriya-shi (JP); Hiroyuki Awano, Noda-shi (JP); Manabu Tani, Moriya-shi (JP); Susumu Imai, Toride-shi (JP)

Correspondence Address: OLIFF & BERRIDGE, PLC, P.O. BOX 19928, ALEXANDRIA, VA, 22320, US

(73) Assignee: HITACHI MAXELL, LTD., Ibaraki-shi (JP)

(21) Appl. No.: 10/895,910

(22) Filed: Jul. 22, 2004

(30) Foreign Application Priority Data
Jul. 24, 2003 (JP) 2003-279268
Feb. 19, 2004 (JP) 2004-043597

(51) Int. Cl. G11B 11/00

(52) U.S. Cl. 369/13.26; 369/13.24

(57) ABSTRACT

A means is provided to determine, accurately in a shorter period of time, an optimum reproducing laser beam intensity for reproducing user data or various management data on a magneto-optical recording medium based on the magnetic amplifying magneto-optical transfer system. In a method for determining the reproducing laser beam intensity of the present invention, a test reproduction area, which is formed of maze magnetic domains having random sizes not subjected to any recording process and provided on a magneto-optical recording medium based on Zero-Field MAMMOS, is irradiated with a laser beam before reproducing user information while changing the laser beam intensity to detect a magneto-optical signal. Subsequently, the reproducing laser beam intensity is determined for user information on the basis of the magneto-optical signal obtained from the test reproduction area.

### BACKGROUND OF THE INVENTION

1. Field of the Invention

The present invention relates to a method for determining a reproducing light beam intensity for a magneto-optical recording medium and a recording and reproducing apparatus. In particular, the present invention relates to a method for determining a reproducing light beam intensity for a magneto-optical recording medium of the type in which a magneto-optical signal is amplified and reproduced, and a recording and reproducing apparatus.

2. Description of the Related Art

The optical recording medium occupies an important position as a portable memory medium. However, it is increasingly expected to realize the convenient property and the large storage capacity thereof as compared with the conventional medium, on account of the development of the information communication instruments. A data management system, into which a highly reliable optical disk with easy maintenance is incorporated, attracts the attention in certain worksites such as enterprises and banks in which huge and important data is handled, unlike any conventional data management system which relies on only the magnetic tape and the hard disk. In the case of the management system as described above, for example, hard disks are provided for the section in which the data is frequently rewritten, and optical disks are provided for the section such as the data library in which the long term information storage is required while the access is occasionally made.

In the case of the hard disk, the drive and the magnetic recording medium are combined as one set or pair. Therefore, if the drive is out of order, the information, which is recorded on the magnetic recording medium that is combined with the drive as the set, cannot be reproduced. Therefore, it is required that the same data is always stored on another hard disk (this process is called “mirroring”), which is provided against the trouble of the drive. However, if the hard disk, which has been subjected to the mirroring as described above, is further out of order before the original hard disk is restored, it is impossible to reproduce the data. On the contrary, in the case of the optical disk, it is enough that the optical disk is merely moved to another drive even when the drive is out of order. Therefore, it is possible to remarkably shorten the time required for the trouble shooting. Further, there is no risk of loss of the important information. In view of the advantage as described above, an optical disk is demanded, which is capable of performing high density recording and which has high reliability.

Usually, a groove (track) is previously formed in a spiral form on the substrate of the optical disk. The information is recorded and reproduced by scanning the groove across the laser beam. In the case of the magneto-optical recording medium which is one of the optical disks, a magnetic layer, on which the information is to be recorded as magnetization information, is formed on the substrate. The information is recorded as magnetic domains (recording marks) having different directions of magnetization. The two types of reproduced signals, which have different magneto-optical effects, are detected depending on the directions of magnetization of the magnetic domains.

In order to realize a large capacity of the magneto-optical recording medium, it is necessary that the track spacing (track pitch) is narrowed, and the spacing distance between recording marks is narrowed. However, if the track spacing and the spacing distance between recording marks are smaller than the spot diameter λ/NA (λ: wavelength of laser beam, NA: numerical aperture of focusing lens) of the laser beam, a plurality of recording marks are included in the light spot. Therefore, a problem arises such that it is impossible to distinguish the individual recording marks.

As methods for solving this problem, two reproducing methods have been suggested for the magneto-optical recording medium, i.e., the magnetic super resolution system and the magnetic domain-expanding reproducing system or the magnetic amplifying magneto-optical system. A magneto-optical recording medium based on the magnetic super resolution system (for example, Japanese Patent Application Laid-open No. 6-150418) principally comprises a recording layer in which recording magnetic domains corresponding to information are recorded, and a magnetic layer which assists the reproduction of the recording magnetic domains. In the case of the magnetic super resolution system, the magnetic characteristic of the magnetic super resolution medium is combined with the temperature distribution in the spot of the reproducing light beam which is radiated on the magneto-optical recording medium during the reproduction of information. Accordingly, it is possible to reproduce the information while effectively exceeding the resolution of the reproducing light beam. However, in the case of the magneto-optical recording medium based on the magnetic super resolution system, the spot size of the reproducing light beam contributing to the reproduction is decreased. Therefore, the amplitude of the reproduced signal is also decreased, and S/N is decreased as well.

On the other hand, the magnetic domain-expanding reproducing system includes the magnetic amplifying magneto-optical transfer system (for example, Japanese Patent Application Laid-open No. 8-7350) and the domain wall displacement system (for example, Japanese Patent Application Laid-open No. 6-295479). For example, a magneto-optical recording medium based on the magnetic amplifying magneto-optical transfer system (referred to as MAMMOS (Magnetic Amplifying Magneto-Optical System) as well) principally comprises a recording layer in which information is recorded as magnetic domains, and a reproducing layer in which magnetic domains transferred from the recording layer are expanded to perform reproduction. In the case of the magneto-optical recording medium based on the magnetic amplifying magneto-optical transfer system, the reproducing light beam is radiated on the magneto-optical recording medium to effect the heating. Accordingly, the magnetic domains in the recording layer are transferred to the reproducing layer, and the reproducing magnetic field is used to expand the magnetic domains having been transferred to the reproducing layer. Therefore, even when information is recorded as minute recording magnetic domains (recording marks) in the recording layer, the reproduced signal can be detected from the magnetic domains expanded in the reproducing layer during the reproduction. Therefore, it is possible to reproduce the information with a sufficient signal amplitude. Also in the case of the magneto-optical recording medium known as the type of the domain wall displacement system (DWDD), magnetic domains can be expanded to reproduce information in the same manner as in the magnetic amplifying magneto-optical transfer system. Therefore, as for the high recording density medium, the magneto-optical recording medium based on the magnetic domain-expanding reproducing system is more effective than the magneto-optical recording medium based on the magnetic super resolution system.

When the magneto-optical recording medium based on the magnetic domain-expanding reproducing system is used as described above, then it is possible to distinguish recording marks formed with magnetic domains having sizes of not more than the resolution of the laser beam, and it is possible to expand the magnetic domains so that the reproduction is successfully performed. Therefore, the reproduction can be performed at sufficient S/N. However, when information is reproduced on the magneto-optical recording medium based on the magnetic domain-expanding reproducing system, the range of the laser beam intensity, in which the recording and reproduction can be performed, is limited to a narrower range as compared with the conventional magneto-optical recording medium. Therefore, it is necessary that the laser beam intensity, which is used in order to perform the optimum recording and reproduction, is previously selected in a strict manner. Further, the recording condition and the reproducing condition are necessarily correlated to one another to a great extent in view of the property of the magneto-optical recording medium. It is difficult to simultaneously optimize the recording condition and the reproducing condition.

In order to solve the problem involved in the magneto-optical recording medium based on the magnetic domain-expanding reproducing system as described above, for example, in the case of the magneto-optical recording medium based on the domain wall displacement system, a method has been suggested (see, for example, Japanese patent Application Laid-open No. 2001-035029, pp. 4-8, FIGS. 1-5), in which the optimum reproducing power is determined by using the inherent properties possessed by the magneto-optical recording medium based on the domain wall displacement system when the test read is performed, i.e., the reproduced signal brought about by the domain wall displacement from the frontward position in the traveling direction of the reproducing light beam and the reproduced signal brought about by the domain wall displacement from the rearward position in the traveling direction.

Also in the case of the magneto-optical recording medium based on the magnetic amplifying magneto-optical transfer system, the reproducing condition and the recording condition are greatly correlated to one another in view of the property thereof. Therefore, it is impossible to simultaneously determine the optimum recording condition and the optimum reproducing condition. The following method is a general method for determining the optimum reproducing light beam intensity and the optimum recording light beam intensity for the laser beam to be radiated onto the magneto-optical recording medium based on the magnetic amplifying magneto-optical transfer system. That is, for example, as shown in FIG. 13, the routine is repeated several times, in which the reproducing light beam intensity is firstly fixed to determine the optimum value of the recording laser beam intensity, and the optimized recording light beam intensity is fixed to determine the optimum value of the reproducing light beam intensity. Another method is also available, in which the procedure is reversely performed as follows. That is, the routine is repeated several times, in which the recording light beam intensity is firstly fixed to determine the optimum value of the reproducing light beam intensity, and the optimized reproducing light beam intensity is fixed to determine the optimum value of the recording light beam intensity.

However, in the case of the repeating methods as described above, the necessary number of times of the routine repetition is increased. Therefore, a problem arises such that a long period of time is required to determine the optimum reproducing light beam intensity and the optimum recording light beam intensity of the laser beam. Further, the number of times of the routine repetition and the convergence value undergo the appearance of any difference in some cases, and it is impossible to determine the optimum reproducing light beam intensity and the optimum recording light beam intensity in other cases, depending on the initial value of any one of the laser beam intensities upon the start of the routine.

Therefore, it is demanded for the magneto-optical recording medium based on the magnetic amplifying magneto-optical transfer system that the optimum recording light beam intensity and the optimum reproducing light beam intensity are determined in shorter periods of time in order to quickly record and reproduce the user data and the management data. Further, in order to improve the reliability of the magneto-optical recording medium based on the magnetic amplifying magneto-optical transfer system, a method is demanded, in which the optimum recording light beam intensity and the optimum reproducing light beam intensity are determined with ease depending on the individual characteristics of the medium even in a variety of environments.

### SUMMARY OF THE INVENTION

An object of the present invention is to provide a means for determining, accurately in a shorter period of time, the optimum reproducing laser beam intensity in order to reproduce user data and/or various management data on a magneto-optical recording medium based on the magnetic amplifying magneto-optical transfer system or the Magnetic Amplifying Magneto-Optical System (MAMMOS). Another object of the present invention is to provide a method for setting the reproducing laser beam intensity in order to improve and reliability of a medium itself by expanding or spreading various characteristic margins of the magneto-optical recording medium based on the magnetic amplifying magneto-optical transfer system.

According to a first aspect of the present invention, there is provided a method for determining a reproducing light beam intensity for a magneto-optical recording medium, which is provided with a recording layer for recording information as magnetic domains, a reproducing layer for magnetically transferring the magnetic domains of the recording layer and an intermediate layer provided between the recording layer and the reproducing layer, and in which the magnetic domains magnetically transferred to the reproducing layer are expanded by being irradiated with a reproducing light beam to amplify and reproduce a magneto-optical signal; the method for determining the reproducing light beam intensity comprising detecting the magneto-optical signal by radiating the light beam onto a non-recorded area of the magneto-optical recording medium while changing a light intensity; and determining an optimum reproducing light beam intensity on the basis of magneto-optical signals detected from the non-recorded area at respective light intensities.

In the method for determining the reproducing light beam intensity of the present invention, the non-recorded area may have magnetic domains of random sizes.

In the method for determining the reproducing light beam intensity of the present invention, the non-recorded area may be a test reproduction area which is previously provided on the magneto-optical recording medium and which is prohibited from writing.

In this specification, the term “non-recorded area” refers to an area in which the recording process is not performed on the magneto-optical recording medium. The area may exist in an arbitrary area on the magneto-optical recording medium. Alternatively, the non-recorded area may be provided as the test reproduction area in which the writing is prohibited in a predetermined area on the magneto-optical recording medium. For example, all of the area on the magneto-optical recording medium is in the non-recorded state immediately after the production of the magneto-optical recording medium. Therefore, in this case, an arbitrary area on the magneto-optical recording medium may be used as the non-recorded area. When user information or the like is recorded in accordance with the format as shown in FIG. 3, the non-recorded area may be previously provided at predetermined positions as indicated by test zones (I) to (III) depicted in FIG. 3.

The method for determining reproducing light beam intensity in accordance with the first aspect of the present invention is suitable for a magneto-optical recording medium based on the Magnetic Amplifying Magneto-Optical System in which no external magnetic field is required upon reproducing information (hereinafter referred to as Zero-Field MAMMOS). Such a magneto-optical recording medium based on the use of the Zero-Field MAMMOS principally includes a recording layer in which information is recorded as magnetic domains, a reproducing layer in which magnetic domains transferred from the recording layer are expanded to perform reproduction, and a trigger layer (intermediate layer) which controls a magnetic exchange-coupling force exerted between the recording layer and the reproducing layer. A brief explanation will be made below regarding the principles of the reproduction of information on the magneto-optical recording medium based on the Zero-Field MAMMOS.

The recording layer is formed of a rare earth transition metal alloy composed of, for example, elements such as Tb, Fe and Co, and is designed to exhibit the ferrimagnetism in which the transition metal is dominant (hereinafter referred to as “Transition Metal rich” or “TM rich”) from room temperature up to its Curie temperature, and the composition of the recording layer is selected so that the recording layer is a perpendicularly magnetizable film. Since the recording layer is designed to have sufficiently large Curie temperature and coercivity, even when irradiated with a reproducing light beam upon reproducing information, the magnetization of the recording magnetic domains corresponding to information is retained. The reproducing layer is formed of a rare earth transition metal alloy composed of, for example, elements such as Gd, Fe and Co, and is designed to exhibit the ferrimagnetism in which the rare earth metal is dominant (hereinafter referred to as “Rare Earth rich” or “RE rich”) from room temperature up to its Curie temperature, and the composition of the reproducing layer is selected so that the reproducing layer is a perpendicularly magnetizable film. The trigger layer is formed of a rare earth transition metal alloy composed of, for example, elements such as Tb and Fe. However, in the following explanation, it is assumed that the trigger layer is formed of a TM rich rare earth transition metal alloy, and is designed to have the perpendicular magnetization at the temperature which is sufficiently lower than the Curie temperature of the trigger layer. In addition, the reproducing layer is designed so that a size of a minimum magnetic domain which is capable of existing stably in the reproducing layer, namely a so-called minimum magnetic domain diameter, is larger than that of the recording layer. Usually, the minimum magnetic domain diameter of the reproducing layer is adjusted so that the minimum magnetic domain diameter of the reproducing layer is approximately equivalent to the diameter of the light spot of the reproducing light beam.

An explanation will be made below with reference to FIGS. 9 to 12 regarding the principle of magnetic domain expansion in the reproducing layer of the magneto-optical recording medium based on the Zero-Field MAMMOS. FIG. 9 shows states of respective magnetic domains formed in the recording layer 3, the trigger layer 5, and the reproducing layer 6 of the magneto-optical recording medium based on the Zero-Field MAMMOS before being irradiated with the reproducing light beam. As shown in FIG. 9, it is assumed that all of the respective magnetic domains formed in the respective layers have an identical size in the disk-traveling direction before being irradiated with the reproducing light beam. In FIG. 9, thick arrows (blanked arrows) indicate entire (combined) magnetizations of the respective layers. Thin arrows (black arrows), which are depicted at the inside of the thick arrows, indicate the magnetic spins of the transition metals (Fe and Co). The recording layer 3 and the trigger layer 5 are TM rich. Therefore, the respective entire magnetizations thereof are directed in the same direction as that of the spin of the transition metal in the magnetic domains included in the same vertical column. On the other hand, the reproducing layer 6 is RE rich. Therefore, the entire magnetization thereof is directed in the direction opposite to that of the spin of the transition metal.

The respective transition metals of the recording layer 3, the trigger layer 5, and the reproducing layer 6 are coupled to one another by the aid of the strong coupling force of not less than several 10 kOe at room temperature. Therefore, as shown in FIG. 9, all of the thin arrows, which indicate the magnetic spins of the transition metal, are directed in the same direction in the magnetic domains disposed in an identical vertical column of the transition metals of the recording layer 3, the trigger layer 5, and the reproducing layer 6. Thus, the entire magnetization of the magnetic domains of the reproducing layer 6 is directed mutually opposite to the entire magnetizations of the magnetic domains of the trigger layer 5 and the recording layer 3 disposed thereunder. The magnetic domains of the recording layer 3 are transferred in the opposite direction to the reproducing layer 6. It is now assumed that the respective magnetic domains of the trigger layer 5 and the reproducing layer 6 are conceptually regarded as magnets 5′, 6′ as shown on the right side in FIG. 9. The state, in which the entire magnetizations of the trigger layer 5 and the reproducing layer 6 are directed in the mutually Opposite directions, is similar or equivalent to the state in which the same poles of the magnets 5′, 6′ are disposed closely to one another. This state is extremely unstable magnetostatically. That is, the state is unstable due to the repulsive force of the magnetostatic energy exerted between the trigger layer 5 and the reproducing layer 6. However, the exchange coupling force, which is mutually brought about by the spins of the transition metals of the trigger layer 5 and the reproducing layer 6, is stronger than the repulsive force of the magnetostatic energy before being irradiated with the reproducing light beam. Therefore, the state is continued as shown in FIG. 9, in which the entire magnetizations of the trigger layer 5 and the reproducing layer 6 are directed in the mutually opposite directions.

As shown in FIG. 10, when a reproducing light beam 100 is collected with an objective lens 90 and radiated onto the magneto-optical recording medium so that a light spot S is formed on the reproducing layer 6 in order to reproduce information, then the temperature distribution is generated in the light spot S in accordance with the light intensity distribution of the reproducing light beam 100, and especially the temperature is raised at portions in the vicinity of the center of the light spot S. In this situation, in an area 100 of the heated trigger layer 5 (hereinafter also referred to as “reproducing temperature area”), the trigger layer 5 functions to cut off the magnetic coupling (exchange coupling) between a magnetic domain 150 of the recording layer 3 disposed under the trigger layer 5 and a magnetic domain 130 of the reproducing layer 6 disposed over the trigger layer 5. A method for cutting off the exchange coupling force, may be a method, for example, in which the exchange coupling force between the recording layer 3 and the reproducing layer 6 is cut off by changing the magnetization of the reproducing temperature area 100 in the trigger layer 5 from the perpendicular magnetization to the in-plane magnetization. Another method is also available in which the exchange coupling force between the recording layer 3 and the reproducing layer 6 is cut off by extinguishing the magnetization of the reproducing temperature area 100 in the trigger layer 5. A consideration will now be made as shown in FIG. 10 about a magnetic domain 230 of the reproducing layer 6, which is disposed adjacently to the magnetic domain 130 of the reproducing layer 6 located over the reproducing temperature area 110, and about a magnetic domain 250 of the recording layer 3 disposed thereunder.

As shown in FIG. 11A, it is assumed that a domain wall 260 of the magnetic domain 230 of the reproducing layer 6 is not displaced and the state is maintained as it is when the reproducing light beam 100 is radiated. On this assumption, the relationship between the repulsive force of the magnetostatic energy exerted on the lower surface of the reproducing layer 6 and the attracting force (exchange coupling force) of the exchange energy is shown in FIG. 11B. However, since the magneto-optical recording medium advances relative to the reproducing light beam 100 in the direction of the arrow indicated in broken line in FIG. 11A, the reproducing temperature area 110 of the trigger layer 5, in which the exchange coupling force exerted between the recording layer 3 and the reproducing layer 6 is cut off, is formed in an area disposed on the side of the disk traveling direction in the reproducing light spot S (on the left side in FIG. 11A), rather than in the central portion in the reproducing light spot S. In addition, as shown in FIG. 11A, the large attracting force of the exchange energy and the relatively large repulsive force of the magnetostatic energy are exerted on the reproducing layer 6 in a state in which the temperature is still low at the portion disposed on the right side in the reproducing light spot S.

The attracting force of the exchange energy is the attracting force which is generated on the basis of the exchange coupling energy between the transition metal of the reproducing layer 6 and the transition metal of the trigger layer 5. As shown in FIG. 11B, the attracting force of the exchange energy exhibits an extremely large value in the low temperature area, and the attracting force of the exchange energy exceeds the repulsive force of the magnetostatic energy, because the transition metals mutually exhibit the strong coupling force. However, as shown in FIG. 11B, the attracting force of the exchange energy is suddenly decreased in accordance with the approach from the low temperature area to the reproducing temperature area, and the attracting force of the exchange energy is zero in the reproducing temperature area, for the following reason. That is, the trigger layer 5 functions in the reproducing temperature area to cut off the exchange coupling force exerted between the recording layer 3 and the reproducing layer 6. On the other hand, the repulsive force of the magnetostatic energy is the repulsive force which is based on the magnetostatic energy exerted between the entire magnetization of the trigger layer 5 and the entire magnetization of the reproducing layer 6 directed in the mutually opposite directions. As shown in FIG. 11B, the repulsive force of the magnetostatic energy is decreased, because the magnetization of the trigger layer 5 is decreased in accordance with the approach from the low temperature area to the reproducing temperature area. However, the repulsive force of the magnetostatic energy is not zero even in the reproducing temperature area, and the repulsive force of the magnetostatic energy has a predetermined value. That is, the repulsive force of the magnetostatic energy is exerted on the magnetic domain 270 of the reproducing layer 6 disposed over the reproducing temperature area 110, for the following reason. That is, as shown in FIG. 11A, the magnetization of the magnetic domain 270 of the reproducing layer 6 disposed over the reproducing temperature area 110 is directed opposite to the magnetization of the magnetic domain 280 of the recording layer 3 disposed under the reproducing temperature area 110, and the repulsive force is exerted between the magnetic domains.

An interface area 140, disposed between the trigger layer 5 and the reproducing layer 6 as shown in FIG. 1A, is heated to a temperature in the vicinity of the boundary between the reproducing temperature area and the low temperature area. In the interface area 140, the magnetostatic repulsive force exceeds the exchange coupling force. In this case, as shown in FIG. 12A, the repulsive force of the magnetostatic energy firstly exceeds the attracting force of the exchange energy in the magnetic domain 230′ disposed on the left side of the magnetic domain 230 of the reproducing layer 6. Accordingly, the magnetic domain 230′ is reversed. The minimum magnetic domain diameter of the expanded reproducing layer 6 is larger than the minimum magnetic domain diameter of the recording magnetic domain. The magnetic characteristics of the expanded reproducing layer 6 are adjusted so that the minimum magnetic domain diameter is approximately equivalent to the diameter of the light spot. Therefore, the magnetic domain of the expanded reproducing layer 6 is expanded to be approximately equal to the light spot diameter as indicated by the magnetic domain 230A shown in FIG. 12B. When the magnetic domain expansion as described above is utilized, a large reproduced signal can be detected from the reproducing layer.

The magneto-optical recording medium based on the zero-Field MAMMOS as described above includes those of the type in which the laser beam for recording and reproducing information is radiated onto the magnetic layer through the substrate (hereinafter referred to as “substrate incident type”) and those of the type in which the laser beam is directly radiated onto the magnetic layer without passing through the substrate (hereinafter referred to as “first surface type”).

When each of the magnetic layers of the magneto-optical recording medium based on the first surface type Zero-Field MAMMOS is formed by means of the sputtering, the magnetic layers are stacked on the substrate in an order of the recording layer, the trigger layer, and the reproducing layer. In this procedure, the magnetic domains of the recording layer are not initialized in any one of the directions (upward direction or downward direction) at the point of time at which the recording layer is formed. Magnetic domains having various sizes are formed in a maze or labyrinthine pattern in the recording layer (such magnetic domains are hereinafter referred to as “random size maze magnetic domain”). When the magnetic characteristics of the respective layers are compared with each other, then the coercivity of the recording layer is larger than those of the trigger layer and the reproducing layer, and the magnitude of the saturation magnetization of the recording layer is smaller than those of the trigger layer and the reproducing layer. Therefore, the magnetizations of the trigger layer and the reproducing layer are affected by the magnetization state of the recording layer at the point of time at which the film formation process is completed, i.e., at the point of time before the information recording and/or the recording process by the initialization is performed for the recording layer. The random size maze magnetic domains generated in the recording layer are transferred to the reproducing layer via the trigger layer. FIG. 1 shows an example of such a situation. FIG. 1 was obtained when the reproducing layer surface was observed by using MFM (Magnetic Force Microscope). An area 11 shown in FIG. 1 is an area in which the random size maze magnetic domains are formed. An area 12 is an area in a state in which the magnetic domains are initialized in the upward direction or in the downward direction.

When the magnetron sputtering is used, the random size maze magnetic domains as described above are formed when the electric discharge distance is provided to some extent between the sputtering target and the film formation surface. However, if the electric discharge distance between the sputtering target and the film formation surface is small, the random size maze magnetic domains as shown in the area 11 in FIG. 1 are hardly formed, because the recording layer is affected by the leak magnetic field from the magnet for the magnetron sputtering. That is, when the recording layer is formed in a state in which the coercivity of the recording layer is larger than the leak magnetic field from the magnet for the magnetron sputtering, the random size maze magnetic domains are formed as shown in the area 11 in FIG. 1.

On the other hand, in the case of the magneto-optical recording medium based on the Zero-Field MAMMOS of the substrate incident type, when the magnetic layers are formed by the sputtering, the reproducing layer, the trigger layer, and the recording layer are formed in this order on the substrate. In this case, the recording layer is affected during the film formation by the magnetizations of the reproducing layer and the trigger layer as well as by the leak magnetic field from the magnet for the magnetron sputtering. When the total sum of the magnetizations is smaller than the coercivity of the recording layer, then the random size maze magnetic domains as shown in the area 11 in: FIG. 1 are also formed in the recording layer of the magneto-optical recording medium based on the Zero-Field MAMMOS of the substrate incident type, and the maze magnetic domains are transferred to the reproducing layer via the trigger layer.

The trigger layer may be heated to a temperature approximate to the Curie temperature by radiating the laser beam onto the magnetic layer without applying any magnetic field after the completion of the film formation process. In this case, the exchange coupling between the recording layer and the reproducing layer is once intercepted by the laser beam radiation. After the cooling, the random size maze magnetic domains of the recording layer are transferred to the reproducing layer again via the trigger layer in accordance with the exchange coupling between the respective layers. Therefore, the random size maze magnetic domains of the recording layer can be transferred to the reproducing layer more correctly.

In the method for determining the reproducing light beam intensity of the present invention, the light beam is firstly radiated onto the area having the random size maze magnetic domains as shown in the area 11 depicted in FIG. 1, i.e., onto the non-recorded area while changing the light intensity on the magneto-optical recording medium based on the Zero-Field MAMMOS to detect the magneto-optical signal from the non-recorded area. Subsequently, the optimum reproducing light beam intensity is determined on the basis of the magneto-optical signals detected from the non-recorded area at the respective light intensities.

An explanation will be made below about an example of the method for determining the reproducing light beam intensity of the present invention. When the magneto-optical signal is detected by radiating the reproducing light beam onto the non-recorded area (test reproduction area) having the random size maze magnetic domains as shown in the area 11 depicted in FIG. 1, the maze magnetic domains are subjected to the expansion and the reproduction as pseudo-random magnetic domains. According to a verifying experiment performed by the inventors, when the magneto-optical signal is detected by radiating the light beam at the determined optimum reproducing light beam intensity onto the test reproduction area having the random size maze magnetic domains as shown in the area 11 in FIG. 1, it has been found out that the magneto-optical signals are obtained at identical signal amplitude from the magnetic domains (recording marks) having various sizes formed on the test reproduction area. Specified situations are shown in FIG. 5.

According to a verifying experiment performed by the inventors, it has been found out that the following phenomenon occurs when the magneto-optical signal obtained from the test reproduction area is measured by radiating the light beam onto the test reproduction area while increasing the light intensity with respect to the magneto-optical recording medium based on the Zero-Field MAMMOS having the test reproduction area formed with the random size maze magnetic domains.

(1) When the light intensity is sufficiently low, then parts of the magnetic domains in the test reproduction area cause the expansion failure, and the amplitude value of the magneto-optical signal waveform is dispersed (FIG. 5A). The expansion failure tends to occur in the magnetic domains having magnetic domain areas which are spread over the tracks other than the track principally irradiated with the light beam. In the case of the magnetic domains as described above, only the portions of the magnetic domains irradiated with the light beam are expanded. Therefore, when the magnetic domain area irradiated with the light beam is small, the influence is strongly exerted by the exchange coupling force acting on the recording layer, the trigger layer, and the reproducing layer of the remaining magnetic domain area not irradiated with the light beam. Therefore, it is considered that the magnetic domain expansion failure tends to take place.

(2) When the light intensity is gradually increased, the magnetic domain expansion failure is decreased because the exchange coupling force acting on the recording layer, the trigger layer, and the reproducing layer is weakened, but the voltage variation or fluctuation is increased for the entire magneto-optical signal waveform (FIG. 5B) probably for the following reason. That is, it is considered that this situation occurs because of the presence of the dispersion in intensity of the exchange coupling force of the random size maze magnetic domain in the circumferential direction of the identical track.

(3) When the light intensity is further increased, then the magnetic domain is subjected to the normal expansion and the reproduction, the magnetic domain expansion failure and the voltage variation of the magneto-optical signal waveform disappear, and the magneto-optical signal waveform having the constant amplitude is obtained (FIG. 5C). When the error rate is measured by reproducing information at the light intensity in the state of (3), the minimum error rate has been successfully obtained.

That is, it has been found out that the light beam is radiated onto the test reproduction area formed with the random size maze magnetic domains as shown in the area 11 in FIG. 1, and the light intensity, at which the amplitudes of the magneto-optical signals are approximately identical, can be used as the optimum reproducing light beam intensity for reproducing the user information and the various management information. However, in order to obtain the optimum value, it is necessary to judge the light intensity areas of the states of (1) and (2) described above.

In order to determine the reproducing light beam intensity, the determination of the optimum reproducing light beam intensity of the present invention may include measuring a peak value of the magneto-optical signal from the non-recorded area, sampling the magneto-optical signal obtained from the non-recorded area at a predetermined sampling interval, and comparing the peak value of the magneto-optical signal with a sampling value of the magneto-optical signal to determine the reproducing light beam intensity.

In the method for determining the reproducing light beam intensity of the present invention, at first, the light beam is radiated onto the test reproduction area formed with the random size maze magnetic domains not subjected to the recording process to measure the maximum and minimum peak values of the amplitude of the magneto-optical signal waveform. However, in this procedure, it is preferable that the peak value of the amplitude of the magneto-optical signal waveform is measured only at the initial value of the light intensity. However, the peak value may be measured every time when the light intensity is changed.

Subsequently, the magneto-optical signals, which are obtained from the test reproduction area at the respective light intensities, are sampled at predetermined sampling intervals to measure the sampling values of the magneto-optical signal obtained from the test reproduction area. The peak values of the magneto-optical signal obtained from the test reproduction area are compared with the sampling values of the magneto-optical signal at the respective light intensities to determine the optimum reproducing light beam intensity.

A variety of methods may be conceived as the method for determining the optimum reproducing light beam intensity by comparing the sampling value and the peak value of the magneto-optical signal. Any arbitrary method may be used depending on the standard and the specification of the recording and reproducing apparatus and the magneto-optical recording medium. For example, the number of sampling values (expansion failure) is counted, the sampling values being not included within a predetermined range with respect to the peak value of the magneto-optical signal, of a plurality of sampling values obtained from the test reproduction area at predetermined sampling intervals. The light intensity, at which the counted number (miscount number) is minimum, may be regarded as the optimum reproducing light beam intensity. Alternatively, the number of sampling values (normal reproduction) is counted, the sampling values being included within a predetermined range with respect to the peak value of the magneto-optical signal. The light intensity, at which the counted number is maximum, may be regarded as the optimum value.

Next, an explanation will be made about an example of another method for determining the reproducing light beam intensity, the method being different from the method for determining the optimum reproducing light beam intensity by comparing the sampling value and the peak value of the magneto-optical signal from the non-recorded area as described above.

In the method for determining the reproducing light beam intensity of the present invention, the determination of the optimum reproducing light beam intensity may include determining a first moving average value at a delay interval T1 with respect to the magneto-optical signal from the non-recorded area, determining a second moving average value at a delay interval T2 with respect to the magneto-optical signal from the non-recorded area, and comparing the first moving average value with the second moving average value to determine the reproducing light beam intensity.

Further, in the method for determining the reproducing light beam intensity of the present invention, the determination of the optimum reproducing light beam intensity may include determining a first moving average value at a delay interval T1 with respect to the magneto-optical signal from the non-recorded area, determining a second moving average value at a delay interval T2 with respect to the magneto-optical signal from the non-recorded area, and determining the reproducing light beam intensity from an absolute value of a difference between the first moving average value and the second moving average value.

The following method is also available other than the method for determining the optimum reproducing light beam intensity by comparing the sampling value and the peak value of the magneto-optical signal from the non-recorded area as described above. That is, the moving average values (first moving average value and second moving average value) are determined at the two types of the delay intervals T1, T2 respectively for the magneto-optical signal from the non-recorded area, and the optimum reproducing light beam intensity is determined by comparing the two obtained moving average values. Specifically, it is preferable that the optimum reproducing light beam of the difference between the two obtained moving average values, especially the accumulated or cumulative value of the absolute values.

According to a verifying experiment performed by the inventors, the amplitude of the reproduced signal is large in the case of the magneto-optical recording medium based on the Zero-Field MAMMOS having the non-recorded area formed with the random size maze magnetic domains. Therefore, the reproduced signal characteristics reside in stochastic or probability characteristics. Further, the inventors have found out the fact that the absolute value of the difference between the two type of the moving average values obtained at the two types of the delay intervals T1, T2 respectively with respect to the magneto-optical signal from the non-recorded area reflects the stochastic characteristics of the reproduced signal characteristics of the magneto-optical recording medium based on the Zero-Field MAMMOS having the non-recorded area formed with the random size maze magnetic domains. An example of the above is shown in FIGS. 16 and 17.

FIG. 16 shows the relationship between the light intensity Pr of the light beam radiated onto the non-recorded area of the magneto-optical recording medium and the accumulated value dMA of the absolute value of the difference between the two moving average values determined at the two types of the delay intervals T1, T2 respectively with respect to the magneto-optical signal from the non-recorded area. FIG. 17 shows the dependency, on the light intensity Pr, of C/N (signal-to-noise ratio) of the magneto-optical recording medium based on the Zero-Field MAMMOS used for the measurement for FIG. 16. As clarified from the comparison of FIGS. 16 and 17, the following fact has been found out. That is, both of the accumulated value dMA and C/N exhibit similar changes with respect to the light intensity Pr. The light intensity Pr, at which the accumulated value dMA is maximum, is approximately the same as the light intensity Pr at which C/N is maximum. That is, as shown in FIGS. 16 and 17, the dependency of the accumulated value dMA on the light intensity Pr of the laser beam is strongly correlated with the dependency of C/N on the light intensity Pr of the laser beam. Therefore, when the light intensity Pr, which maximizes the accumulated value dMA of the absolute value of the difference between the two moving average values determined at the two types of the delay intervals T1, T2 respectively with respect to the magneto-optical signal from the non-recorded area, is selected as the reproducing light beam intensity, it is possible to determine the optimum reproducing light beam intensity.

It is preferable that the values, which are optimized depending on the size distribution of the random size maze magnetic domains formed in the non-recorded area of the magneto-optical recording medium based on the Zero-Field MAMMOS, are set for the two types of the delay intervals T1, T2 described above. The following setting method is specifically available. That is, at first, a plurality of magneto-optical recording media based on the Zero-Field MAMMOS, which have non-recorded areas formed with random size maze magnetic domains, are manufactured. Subsequently, the random size maze magnetic domains in the non-recorded areas are subjected to the reproduction while changing the light intensity with respect to the respective manufactured magneto-optical recording media. Subsequently, reproduced signals are detected by using, for example, a digital oscilloscope. The accumulated value dMA of the absolute value of the difference between the moving average values of the reproduced signal under combined conditions of the respective delay intervals T1, T2 is calculated by variously changing the two types of the delay intervals T1, T2 with respect to the detected reproduced signal. The delay intervals T1, T2 are set so that the dependency of the accumulated value dMA on the light intensity Pr is highly correlated with the dependency of C/N on the light intensity Pr.

In this method, the optimum reproducing light beam intensity is determined by using the two moving average values determined with the two types of the delay intervals respectively with respect to the magneto-optical signal from the non-recorded area. Therefore, it is possible to select the reproducing light beam intensity capable of being secured in relation to the stability for both of the long cycle and the short cycle. The cycle referred to herein is the parameter which depends on the shape of the maze magnetic domain and the frequency of occurrence of the random size maze magnetic domain.

In the method for determining the reproducing light beam intensity of the present invention, the determination of the optimum reproducing light beam intensity may include multiplying an amplitude of the magneto-optical signal from the non-recorded area by a function fi(Pr) in which a value is increased as the light intensity Pr is increased, determining a first moving average value at a delay interval T1 with respect to a signal obtained by multiplying the function fi(Pr), determining a second moving average value at a delay interval T2 with respect to a signal obtained by multiplying the function fi(Pr), determining an accumulated value of an absolute value of a difference between the first moving average value and the second moving average value, and determining the reproducing light beam intensity from the accumulated value.
when the light beam is radiated onto the non-recorded area while changing the light intensity Pr in order to determine the reproducing light beam intensity, if the light intensity Pr subjected to the radiation is extremely large, it is feared that the amplitude of the magneto-optical signal from the non-recorded area may be lowered. This phenomenon occurs due to the following cause. When the light intensity Pr is increased, the temperature of the irradiated medium is also raised. However, when the medium temperature is raised, the Kerr rotation angle is decreased. Therefore, if the light intensity Pr is extremely increased, then the amount of decrease in the amplitude, which is caused by the decrease in the Kerr rotation angle, is increased as compared with the amount of increase in the reflected light beam intensity from the medium, and the amplitude of the magneto-optical signal is lowered in total. Therefore, in the method for determining the reproducing light beam intensity of the present invention, it is preferable that the amplitude of the magneto-optical signal from the non-recorded area is multiplied by the function fi(Pr) in which the value is also increased as the light intensity Pr is increased to control the variation of the amplitude of the magneto-optical signal to be inputted into the calculation of the moving average value. Those usable as the function fi(Pr) include, for example, fi(Pr)=Pr and polynomials such as fi(Pr)=a₁Pr^{b1}+a₂Pr^{b2}+a₃Pr^{b3}.

In the method for determining the reproducing light beam intensity of the present invention, any on of the delay interval T1 and the delay interval T2 may be equal to a channel bit length in a modulation system to be used when user information is recorded.

When any one of the delay interval T1 and the delay interval T2 is equal to the channel bit length in the modulation system to be used when user information is recorded, it is possible to apply the conventional apparatus for signal processing. Therefore, this feature is preferred to realize an apparatus to be used for the method for determining the reproducing light beam intensity of the present invention.

A comparison will now be made between the two methods for determining the reproducing light beam intensity described above, i.e., between the method for determining the optimum reproducing light beam intensity by comparing the sampling value and the peak value of the magneto-optical signal from the non-recorded area and the method for determining the optimum reproducing light beam intensity from the two moving average values determined at the two types of the delay intervals T1, T2 respectively. In the latter method, the optimum reproducing light beam intensity can be determined only by determining the moving average values at the two types of the delay intervals T1, T2 respectively with respect to the magneto-optical signal from the non-recorded area and calculating the absolute value of the difference between the two obtained moving average values. On the other hand, in the former method, it is necessary to perform the steps of determining the sampling value and the peak value of the magneto-optical signal from the non-recorded area while changing the light intensity, and then comparing the peak value and the sampling value to further count the number of expansion failures (miscount number) of the sampling values, in which the number of steps to be performed until the determination of the reproducing light beam intensity is large. Therefore, the latter step makes it possible to determine the reproducing light beam intensity more simply.

On the other hand, in the case of the former method, the number of expansion failures of the sampling values is directly counted. Therefore, even when the medium structure and the production process for the magneto-optical recording medium to be used greatly differ, and the random size maze magnetic domains, which are formed in the non-recorded area, also greatly differ depending on every medium, then it is possible to determine the reproducing light beam intensity more accurately. However, when the medium structure and the production process are controlled so that the random size maze magnetic domains, which are uniform to some extent, are formed when the random size maze magnetic domains are formed, the reproducing light beam intensity can be determined accurately even when any one of the methods is used. Therefore, the latter method is advantageous on condition that the convenience for the method for determining the reproducing light beam intensity is considered.

In the method for determining the reproducing light beam intensity of the present invention, when the test reproduction area is irradiated with the light beam while changing the light intensity, the magneto-optical signal may be detected while changing the light intensity from a lower value to a higher value in accordance with a predetermined step. Reversely, the magneto-optical signal may be detected while changing the light intensity from a higher value to the lower value. However, if the light intensity is too high, there is such a possibility that the recording layer of the test reproduction area is heated to a temperature of not less than the Curie temperature, and the random size maze magnetic domains, which are formed by the sputtering process, disappear. Therefore, it is preferable that the test reproduction process is completed at a point of time at which the optimum reproducing light beam intensity is determined while changing the light intensity from a lower value to a higher value.

In the method for determining the reproducing light beam intensity of the present invention, the method for determining the light beam intensity may be executed before reproducing user information on the magneto-optical recording medium on which the user information is recorded.

According to a second aspect of the present invention, there is provided a method for determining a recording light beam intensity, further comprising determining the recording light beam intensity on the basis of the reproducing light beam intensity obtained by the method for determining the reproducing light beam intensity according to the first aspect.

According to a third aspect of the present invention, there is provided a magneto-optical recording medium based on a magnetic domain-expanding reproducing system, comprising the non-recorded area which is used to determine the optimum reproducing light beam intensity in accordance with the method for determining the reproducing light beam intensity according to the first aspect.

In the magneto-optical recording medium of the present invention, the magneto-optical recording medium may have a plurality of zones, and each of the zones is provided with the non-recorded area.

In the magneto-optical recording medium of the present invention, in order to determine the optimum reproducing light beam intensity by the method for determining the reproducing light beam intensity, it is preferable that a test reproduction area, which is not less than about 10 μm in the circumferential direction of the track, is provided. In particular, it is preferable that a test reproduction area, which resides in an area longer than about 10 μm, is used in combination, or a plurality of test reproduction areas are provided. In such a case, it is possible to decrease the influence of the dispersion of the amplitude variation caused by, for example, any defect on the magneto-optical recording medium. Therefore, it is possible to determine the optimum reproducing light beam intensity more accurately.

As for the substrate for the magneto-optical recording medium of the present invention, a substrate for land/groove recording may be used. Alternatively, a substrate for groove recording may be used, which is provided with a groove for avoiding the crosstalk and the crosswrite (hereinafter referred to as “guard band”), and a groove having, for example, an area for performing the recording and reproduction and an address area. Further alternatively, a substrate for land recording may be used.

In the case of the magneto-optical recording medium of the present invention, the reproducing light beam may be radiated onto the reproducing layer, the intermediate layer, and the recording layer without passing through the substrate during the recording and reproduction of information.

It is preferable that the magneto-optical recording medium of the present invention is provided with synchronization prepits or wobble grooves so that the position of the test reproduction area is correctly indicated in order to determine the reproduction condition.

A recording and reproducing apparatus, which is used for the method for determining the reproducing light beam intensity by comparing the sampling value and the peak value of the magneto-optical signal from the non-recorded area as described above, preferably comprises a synchronization signal-detecting circuit which detects a signal obtained from a wobble groove or a synchronization prepit formed on the magneto-optical recording medium, and an electric circuit which has a sample bold and a peak hold for detecting the sampling value and the peak value of the magneto-optical signal obtained from the test reproduction area, and a comparator for comparing the sampling value and the peak value of the magneto-optical signal. It is obscure that the magnetic domain of what size is formed in the random size maze magnetic domains in the test reproduction area. Therefore, it is preferable that the sampling interval for the magneto-optical signal is an interval of not more than the spot diameter of the radiating light beam.

A brief explanation will now be made about an example of the operation of the recording and reproducing apparatus to be used for the method for determining the reproducing light beam intensity by comparing the sampling value and the peak value of the magneto-optical signal from the non-recorded area. For example, the following situation is assumed. That is, the sampling values (expansion failures) of the magneto-optical signals, which are not included in values within a predetermined range with respect to the peak value of the magneto-optical signal, are subjected to the counting to obtain the number thereof, and the light intensity, at which the count number (miscount number) is minimized, is regarded as the optimum reproducing light beam intensity. The sampling value of the magneto-optical signal, which is detected by the sample hold, is compared with the value within an amplitude range obtained by converting the peak value of the magneto-optical signal obtained by the peak hold with a predetermined magnification range by using the comparator. Subsequently, if the sampling value of the magneto-optical signal is smaller or larger than those included in the amplitude range, the sampling value is counted as the reproduction failure (miscount). The light intensity, at which the miscount number is minimized, is regarded as the optimum reproducing light beam intensity. The situation, in which the sampling value of the magneto-optical signal is smaller than the value within the amplitude range obtained by converting the peak value of the magneto-optical signal with the predetermined magnification range, corresponds to the state (state shown in FIG. 5A) in which parts of the random size maze magnetic domains formed in the test reproduction area cause the expansion failure. The situation, in which the sampling value is larger than the value within the amplitude range obtained by converting the peak value of the magneto-optical signal with the predetermined magnification range, corresponds to the state (state shown in FIG. 5B) in which the magneto-optical signal waveform is subjected to the voltage variation or fluctuation.

According to a fourth aspect of the present invention, there is provided a recording and reproducing apparatus for a magneto-optical recording medium which is provided with a recording layer for recording information as magnetic domains, a reproducing layer for magnetically transferring the magnetic domains of the recording layer and an intermediate layer provided between the recording layer and the reproducing layer, and in which the magnetic domains magnetically transferred to the reproducing layer are expanded by being irradiated with a reproducing light beam to amplify and reproduce a magneto-optical signal; the recording and reproducing apparatus comprising an optical head; a multiplying unit which multiplies, by a predetermined function, an amplitude of a magneto-optical signal from a non-recorded area of the magneto-optical recording medium detected by the optical head; a first circuit unit which calculates a first moving average value at a delay interval T1 with respect to an output signal of the multiplying unit; a second circuit unit which calculates a second moving average value at a delay interval T2 with respect to the output signal of the multiplying unit; a third circuit unit which calculates an absolute value of a difference between the first moving average value and the second moving average value; and a discriminating unit which selects an optimum reproducing light beam intensity on the basis of output information of the third circuit unit.

As described above, according to the method for determining the reproducing light beam intensity of the present invention, the optimum value of the reproducing light beam intensity for the magneto-optical recording medium based on the Zero-Field MAMMOS is determined by radiating the light beam onto the test reproduction area (non-recorded area) formed with the random size maze magnetic domains not subjected to the recording process. Therefore, it is unnecessary to newly record the information for the read test in the test reproduction area. It is possible to determine the optimum reproducing light beam intensity accurately in a shorter period of time. Accordingly, it is possible to shorten the time required until the user data and the management data are reproduced, and it is possible to decrease the damage on the magneto-optical recording medium which would be otherwise involved in the test recording and reproduction. Therefore, it is possible to improve the reliability of the magneto-optical recording medium based on the Zero-Field MAMMOS.

### BRIEF DESCRIPTION OF THE DRAWINGS

FIG. 1 shows a state of random size maze magnetic domains not subjected to the recording process.

FIG. 2 shows a schematic sectional view illustrating a magneto-optical disk based on the first surface type MAMMOS manufactured in a first embodiment.

FIG. 3 schematically shows the data format for a substrate used in the first embodiment.

FIG. 4 shows magneto-optical signal waveforms obtained from a test reproduction area of the magneto-optical disk manufactured in the first embodiment, wherein FIG. 4A shows the magneto-optical signal waveform obtained when the laser beam intensity is 1.0 mW, and FIG. 4B shows the magneto-optical signal obtained when the laser beam intensity is 1.6 mW.

FIG. 5 shows magneto-optical signal waveforms obtained from the test reproduction area of the magneto-optical disk manufactured in the first embodiment, wherein FIG. 5A shows the magneto-optical signal waveform obtained when the laser beam intensity is 1.0 mW, FIG. 5D shows the magneto-optical signal obtained when the laser beam intensity is 1.3 mW, and FIG. 5C shows the magneto-optical signal obtained when the laser beam intensity is 1.6 mW.

FIG. 6 shows a schematic arrangement of a recording and reproducing apparatus used to perform the test reproduction on the magneto-optical disk manufactured in the first embodiment.

FIG. 7 shows the correspondence between the error rate and the miscount number of the magneto-optical disk manufactured in the first embodiment, wherein FIG. 7A shows a relationship between the laser beam intensity and the miscount number obtained from the magneto-optical signal waveform of the test reproduction area, and FIG. 7B shows a relationship between the laser beam intensity and the error rate of the magneto-optical disk used in the embodiment.

FIG. 8 shows a flow chart illustrating the process for determining the recording and reproducing laser beam intensities in the first embodiment.

FIG. 9 explains the principle of reproduction on a magneto-optical recording medium based on the Zero-Field MAMMOS, illustrating the situations of magnetization of a reproducing layer, a trigger layer, and a recording layer before being irradiated with a reproducing light beam.

FIG. 10 explains the principle of reproduction on the magneto-optical recording medium based on the Zero-Field MAMMOS, illustrating a situation in which the reproducing light beam is radiated.

FIG. 11 explains the principle of reproduction on the magneto-optical recording medium based on the Zero-Field MAMMOS, wherein FIGS. 11A and 11B show the relationship between the repulsive force of the magnetostatic energy and the attracting force of the exchange energy when the magnetic domain of the reproducing layer is not expanded.

FIG. 12 explains the principle of reproduction on the magneto-optical recording medium based on the Zero-Field MAMMOS, wherein FIGS. 12A and 12B show situations in which the magnetic domain of the reproducing layer is expanded.

FIG. 13 shows a flow chart illustrating the conventional process for determining the reproducing and recording laser beam intensities.

FIG. 14 shows a schematic arrangement of a difference signal-processing unit of a recording and reproducing apparatus used for a method for determining the optimum reproducing laser beam intensity in a second embodiment.

FIG. 15 shows waveforms obtained by multiplying the amplitude of the magneto-optical signal from the non-recorded area by a function fi(Pr).

FIG. 16 shows the dependency, on the reproducing light beam intensity, of the numerical value dMA calculated on the basis of the absolute value of the difference between moving average values at two different delay intervals T1, T2 with respect to the magneto-optical signal from the non-recorded area in the second embodiment.

FIG. 17 shows the dependency, on the reproducing light beam intensity, of C/N in relation to the magneto-optical recording medium based on the Zero-Field MAMMOS manufactured in the second embodiment.

### DESCRIPTION OF THE PREFERRED EMBODIMENTS

Embodiments of the present invention will be specifically explained below with reference to the accompanying drawings. However, the present invention is not limited thereto.

### First Embodiment

First Surface Type Magneto-Optical Disk

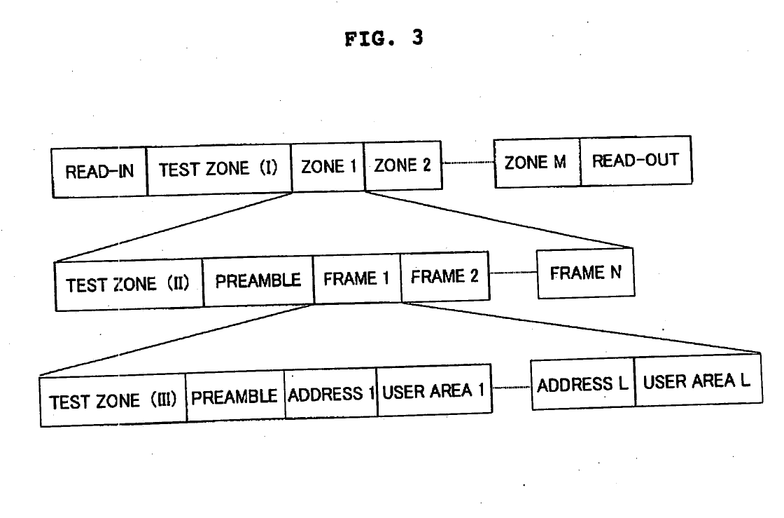

In a first embodiment, a magneto-optical disk based on the first surface type Zero-Field MAMMOS was manufactured. FIG. 2 shows a schematic arrangement of the magneto-optical disk of the first embodiment. As shown in FIG. 2, the magneto-optical disk 10 based on the first surface type Zero-Field MAMMOS manufactured in the first embodiment has a structure comprising a reflective layer 2 (also referred to as “heat sink layer”), a recording layer 3, a paramagnetic layer 4, a trigger layer 5, a reproducing layer 6, an enhancing layer 7, and a protective coat layer 8 which are successively stacked in this order on a substrate 1. The reflective layer 2 is a layer which adjusts the thermal sensitivity of the magneto-optical recording medium during the recording and reproduction of information. The recording layer 3 is a layer on which information is recorded as magnetization information. The paramagnetic layer 4 is a layer which controls the magnitude of the leak magnetic field from the recording layer 3. The trigger layer 5 is a layer which regulates the magnetic exchange coupling between the recording layer 3 and the reproducing layer 6 as described later on. The reproducing layer 6 is a layer in which magnetic domains transferred from the recording layer 3 are expanded. The enhancing layer 7 is a layer in which the reproducing light beam is subjected to the multiple interference in the layer to effectively increase the Kerr rotation angle to be detected. The protective coat layer 8 is a layer which protects the respective layers 2 to 7 described above.

Next, an explanation will be made about a method for manufacturing the magneto-optical disk 10 based on the fist surface type Zero-Field MAMMOS of the first embodiment. At first, a transparent polycarbonate substrate was used for the substrate 1. A groove having a track pitch of 0.3 μm was formed on the surface of the substrate 1 by using an injection molding machine (not shown). In the first embodiment, the substrate 1 was used as a substrate for the land/groove recording. An Al alloy was formed as the reflective layer 2 to have a thickness of 40 nm on the substrate 1. The following film formation method was adopted. That is, an Al alloy target was subjected to the sputtering to form the film.

Subsequently, a TbFeCo film was formed as the recording layer 3 to have a thickness of 60 nm on the reflective layer 2. The following film formation method was adopted. That is, the film was formed by the co-sputtering by using simple substance targets of Tb, Fe, and Co. The composition of the recording layer 3 was adjusted so that the TbFeCo film had the transition metal-dominant perpendicular magnetization from room temperature to the curie temperature, the compensation temperature was about 25° C., and the Curie temperature was about 250° C.

Subsequently, a Gd film was formed as the paramagnetic layer 4 to have a thickness of 0.5 nm on the recording layer 3. The following film formation method was adopted. That is, the film was formed by the sputtering by using a simple substance target of Gd. Subsequently, a transition metal-dominant TbFe film was formed as the trigger layer 5 to have a thickness of 10 nm on the paramagnetic layer 4. The following film formation method was adopted. That is, the film was formed by the co-sputtering by using simple substance targets of Tb and Fe. In this embodiment, the film composition was adjusted so that the compensation temperature of the trigger layer 5 was not more than room temperature.

Subsequently, a GdFeCo film was formed as the reproducing layer 6 to have a thickness of 30 nm on the trigger layer 5. The following film formation method was adopted. That is, the film was formed by the co-sputtering by using simple substance targets of Gd, Fe, and Co. During this process, the film composition was adjusted by controlling the ratio of input electric powers to be supplied to the respective targets. The reproducing layer 6 was a rare earth metal-dominant perpendicular magnetized film from room temperature to the Curie temperature. The Curie temperature was about 260° C., and the compensation temperature was not less than the Curie temperature.

Subsequently, an SiN film was formed as the enhancing layer 7 to have a thickness of 35 nm on the reproducing layer 6. The following film formation method was adopted. That is, the film was formed by the sputtering by using an Si target in an atmosphere of Ar+N₂. Finally, an acrylic ultraviolet-curable resin was applied as the protective coat layer 8 onto the enhancing layer 7, and then the resin was cured by being irradiated with the ultraviolet light to form the protective coat layer 8. The protective coat layer 8 had a thickness of 15 μm. In accordance with the production method as described above, the magneto-optical disk 10 based on the first surface type Zero-Field MAMMOS shown in FIG. 2 was obtained.

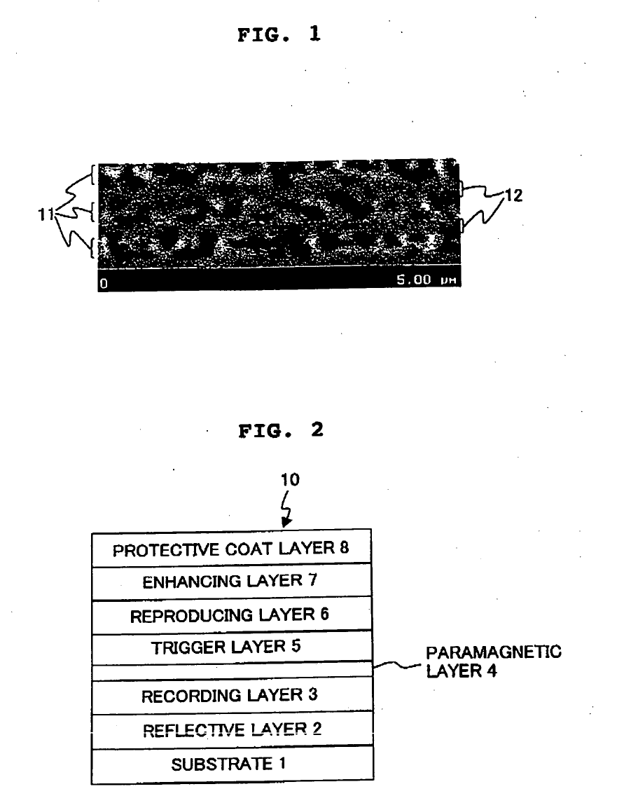

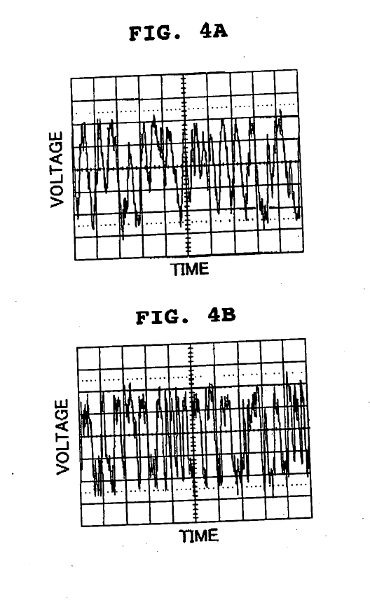

FIG. 3 shows the layout of the data format of the magneto-optical disk 10 based on the first surface type zero-Field MAMMOS manufactured in the first embodiment. In the first embodiment, the substrate for the zone CLV was used. As shown in FIG. 3, zones of a number of M were formed on the disk in the data format of the magneto-optical disk manufactured in the first embodiment. A test zone (I) (test reproduction area), which was formed of random size maze magnetic domains not subjected to the recording process as in the area 11 shown in FIG. 1, was provided before the first zone. A read-in area was provided before the test zone (I), and a read-out area was provided after the Mth zone.

In this embodiment, as shown in FIG. 3, each of the zones was divided into frames of a number of N. A preamble area was provided before the first frame. A test zone (II) (test reproduction area), which was formed of random size maze magnetic domains as indicated by the area 11 in FIG. 1, was provided before the preamble area.

As shown in FIG. 3, each of the frames was divided into addresses of a number of L and user areas of a number of L. The addresses and the user areas were alternately arranged. As shown in FIG. 3, a preamble area was provided before the first address. A test zone (III) (test reproduction area), which was formed of random size maze magnetic domains as indicated by the area 11 in FIG. 1, was provided before the preamble area. That is, in the case of the magneto-optical disk of the first embodiment, the test zone (test reproduction area), which was formed of the random size maze magnetic domains not subjected to the recording process, was provided after the read-in area and at the heads of each of the zones and each of the frames respectively.

The test zone (I) is principally used in order to determine the reproducing light beam intensity upon the start-up of the drive. The test zone (II) is principally used when the reproducing laser beam intensity is optionally determined when information is recorded and reproduced over an area ranging over the respective zones. The test zone (III) is principally used in order to steadily optimize the reproducing laser beam intensity. The preamble area shown in FIG. 3 is a preliminary area to absorb, for example, the rotation jitter of the magneto-optical disk.

In this embodiment, the test reproduction is performed by using any one of the test zones (I) to (III) depending on the object and the area subjected to the reproduction to determine the optimum reproducing laser beam intensity. The recording laser beam intensity is determined, which is determined on the basis of the optimum reproducing laser beam intensity. The laser beam is moved to the objective user area with reference to the address, and then information is recorded and reproduced by radiating the light beam at the determined optimum reproducing and recording laser beam intensities.

Reproduction Characteristic of Test Zone

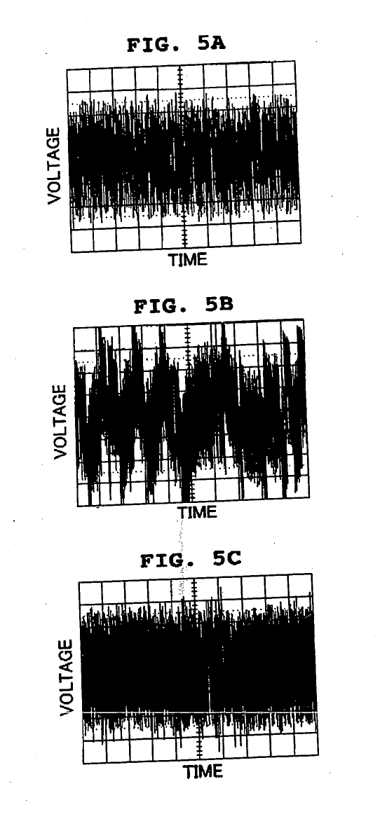

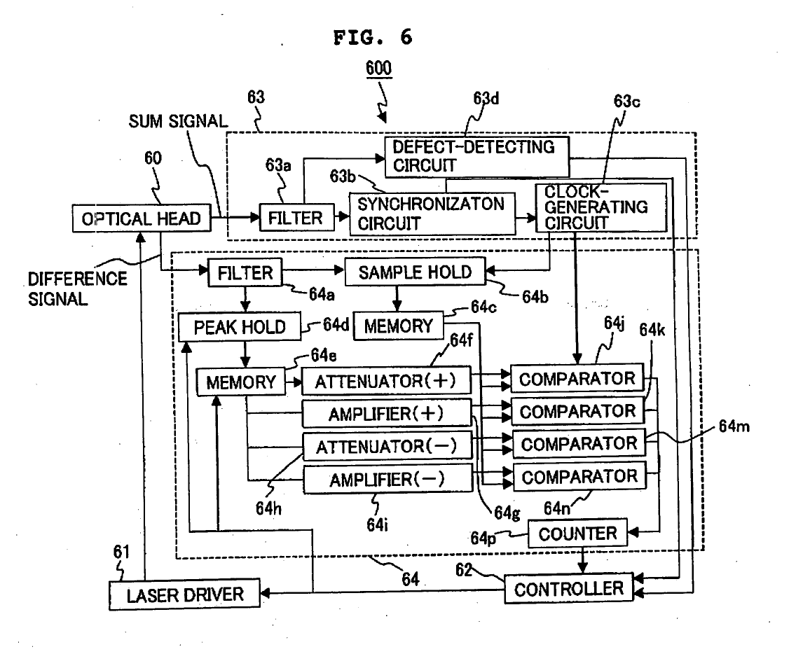

The magneto-optical disk based on the first surface type Zero-Field MAMMOS, which was manufactured in accordance with the production method described above, was installed to a drive (not shown) provided with a laser beam having a wavelength of 405 nm. The laser beam was radiated onto the random size maze magnetic domains formed in the test zone (III) of the magneto-optical disk shown in FIG. 3 to detect the magneto-optical signal. Obtained results are shown in FIGS. 4 and 5. In this evaluation of characteristics, a lens having a numerical aperture of 0.9 was used for the objective lens, and the laser beam was focused so that the laser spot diameter to be radiated onto the magneto-optical disk was about 0.4 μm. Any unnecessary noise was cut for the magneto-optical signal obtained from the test zone (III) by using a low-pass filter having a cutoff of 25 MHz and a high-pass filter having a cutoff of 10 kHz. The linear velocity of the magneto-optical disk was 4 m/s.

FIG. 4 shows magneto-optical signal waveforms obtained from the test zone (III). The time scale of the horizontal axis is 5 μs in total. FIG. 4A shows the magneto-optical signal waveform obtained when the light intensity of the radiated laser beam was 1.0 mw, and FIG. 4B shows the magneto-optical signal waveform obtained when the light intensity of the laser beam was 1.6 mW.

As clarified from FIG. 4A, when the laser beam intensity is 1.0 mW, the amplitude of the magneto-optical signal waveform is dispersed, probably for the following reason. That is, it is considered that parts of the magnetic domains of the random size maze magnetic domains formed in the test zone (III) caused the expansion failure due to the shortage of the laser beam intensity. In the case of the magnetic domain in which the expansion failure is caused, the amplitude of the magneto-optical signal is decreased. Therefore, the amplitude of the magneto-optical signal waveform is dispersed as shown in FIG. 4A. The expansion failure tends to occur in magnetic domains in which the magnetic domain area is spread over the tracks other than the track onto which the laser beam is radiated. In the case of such magnetic domains, only the magnetic domain area, which is irradiated with the laser beam, is expanded. Therefore, it is considered that the magnetic domain expansion failure tends to occur, because of the strong influence of the exchange coupling force acting on the recording layer, the trigger layer, and the reproducing layer in the remaining magnetic domain area not irradiated with the laser beam when the magnetic domain area irradiated with the laser beam is small.

As clarified from FIG. 4B, when the laser beam intensity was 1.6 mW, the magneto-optical signal waveform having approximately constant amplitudes was obtained. This indicates the fact that the random size maze magnetic domains formed in the test zone (III) are normally expanded and reproduced irrelevant to the magnetic domain size when the laser beam intensity is 1.6 mW.

FIG. 5 also shows the magneto-optical signal waveforms obtained from the test zone (III). However, FIG. 5 shows the magneto-optical signal waveforms obtained when the time scale of the horizontal axis was 200 μs in total. That is, FIG. 5 shows situations of the magneto-optical signal waveforms obtained when the time scale of the horizontal axis was spread or widened as compared with FIG. 4. The measurement was performed in the same manner as in FIG. 4 other than the above. FIGS. 5A, 5B, and 5C show the magneto-optical signal waveforms obtained when the laser beam intensity was 1.0 mw, 1.3 mW, and 1.6 mW respectively. When the laser beam intensity is 1.0 mW, the amplitude of the signal waveform is dispersed for the magneto-optical signal waveform as shown in FIG. 5A, probably for the following reason. That is, it is considered that the expansion failure was caused in parts of magnetic domains of the random size maze magnetic domains formed in the test zone (III) due to the shortage of the laser beam intensity.

When the laser beam intensity is increased to be 1.3 mW, the magneto-optical signal waveform is as shown in FIG. 5B. As clarified from FIG. 5B, when the laser beam intensity is 1.3 mw, then the magnetic films are further heated as compared with the case in which the laser beam intensity is 1.0 mW, and hence the exchange coupling force, which is exerted on the recording layer, the trigger layer, and the reproducing layer, is weakened. Therefore, the expansion failure is decreased, and the dispersion of the amplitude of the magneto-optical signal disappears. However, it has been found out that the entire voltage variation or fluctuation of the magneto-optical signal waveform is increased, probably for the following reason. That is, it is considered that the intensity of the exchange coupling of the maze magnetic domains is dispersed in the circumferential direction of the track irradiated with the laser beam.

When the laser beam intensity is further increased to be 1.6 mW, then the amplitudes of the magneto-optical signal waveform are approximately identical, and the entire voltage fluctuation of the signal waveform is not observed as well, as clarified from FIG. 5C. This indicates the fact that the maze magnetic domains formed in the test zone (III) are normally expanded and reproduced irrelevant to the size of the magnetic domain.

A test pattern was recorded in a predetermined area (not shown) of the magneto-optical disk manufactured in the first embodiment, and the test pattern was reproduced to determine the error rate. As a result, the error rate was 2E-2 when the laser beam intensity was 1.0 mw, the error rate was 8E-3 when the laser beam intensity was 1.3 mW, and the error rate was 4E-5 when the laser beam intensity was 1.6 mW. That is, as shown in FIG. 5C, it has been revealed that the error rate is improved at the laser beam intensity (1.6 mW) at which the magneto-optical signal waveform is obtained such that the amplitudes are approximately identical and the entire voltage fluctuation of the signal waveform disappears as well. According to the results as described above, the following fact has been revealed. That is, it is effective to monitor the voltage level of the magneto-optical signal waveform and the amplitude value of the magneto-optical signal waveform as shown in FIGS. 4 and 5 in order to determine the optimum reproducing light beam intensity.

Recording and Reproducing Apparatus

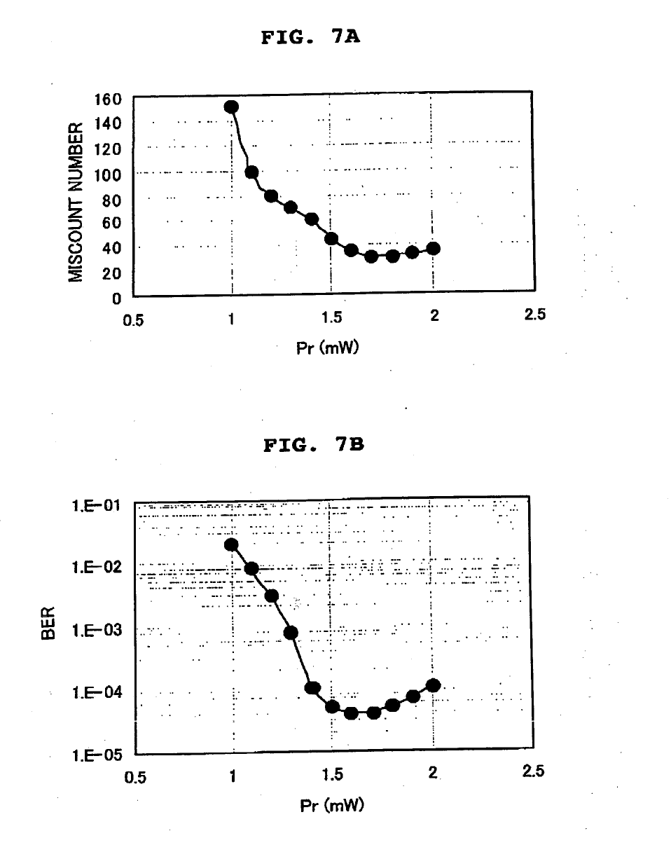

Next, an explanation will be made about a recording and reproducing apparatus used in the first embodiment in order to determine the optimum reproducing light beam intensity. FIG. 6 shows a schematic arrangement of the recording and reproducing apparatus. However, for example, the optical system for converging the laser beam onto the magneto-optical disk and the servo circuit for effecting the scanning on the objective track, which are included in the recording and reproducing apparatus 600 shown in FIG. 6, are the same as those of the conventional recording and reproducing apparatus, which are omitted herein. The directions of the arrows shown in FIG. 6 indicate the directions of the signal.

As shown in FIG. 6, the recording and reproducing apparatus 600, which is used to determine the optimum reproducing laser beam intensity used in the first embodiment, includes an optical head 60 for recording and reproducing information, a laser driver 61 for controlling the operation of the optical head 60, a controller 62 for controlling the laser driver 61, a sum signal-processing system 63 for processing the sum signal detected by the optical head 60, and a difference signal-processing system 64 for processing the difference signal detected by the optical head 60.

As shown in FIG. 6, the sum signal-processing system 63 includes a filter 63a, a synchronization circuit 63b, a clock-generating circuit 63c, and a defect-detecting circuit 63d. Address pits for indicating the test zones (test zones (I) to (III) shown in FIG. 3) to determine the reproducing laser beam intensity, and synchronization pits for correctly recording and reproducing information are previously formed on the substrate of the magneto-optical disk. Reproduced signals, which are obtained from the two types of pits, can be detected from the sum signal (total light amount of the reflected light beam detected by the detector) detected by the optical head. The sum signal-processing system 63 generates the clock signal from the sum signal of the reproduced signals detected by the optical head 60.

As shown in FIG. 6, at first, any unnecessary noise is cut by the filter 63a from the sum signal detected by the optical head 60. A synchronization pattern (synchronization pit), which is formed in the test zone, is captured by the synchronization circuit 63b from the magneto-optical signal from which the noise has been cut. Subsequently, the reference clock, which is used for the recording and reproduction timing for information, is extracted from the captured synchronization signal by using the clock-generating circuit 63c to oscillate the clock signal.

The magneto-optical signal, from which any unnecessary noise is cut by the filter 63a, is fed to the defect-detecting circuit 63d so that the monitoring is performed to investigate whether or not there is any defect in the test zone of the magneto-optical disk on the basis of the magneto-optical signal. In this process, if any spike-shaped noise is present in the magneto-optical signal, it is judged that there is any defect in the test zone of the magneto-optical disk. In this case, the test reproduction in the test zone is stopped, and the test reproduction is performed in another test zone.

As shown in FIG. 6, the difference signal-processing system 64 includes a filter 64a, a sample hold 64b, a peak hold 64d, two memories 64c, 64e, two attenuators 64f, 64h (attenuator (+) and attenuator (−) in FIG. 6), two amplifiers 64g, 64i (amplifier (+) and amplifier (−) in FIG. 6), four comparators 64j, 64k, 64m, 64n, and a counter 64p.

The difference signal, which is detected by the optical head 60, corresponds to the magneto-optical signal detected from the magnetic domains formed on the magneto-optical disk. The magneto-optical signal of the test zone for determining the reproducing laser beam intensity and the user data signal of the user area can be detected from the difference signal. The difference signal-processing system 64 is operated as follows. That is, at first, the difference signal detected by the optical head 60 is subjected to the cutting of any unnecessary noise by the filter 64a as shown in FIG. 6-Subsequently, the magneto-optical signal, from which any noise has been cut, is inputted into the sample hold 64b. The signal is subjected to the sampling at the sampling interval corresponding to the reference clock generated by the clock-generating circuit 63c to extract a sampling value vs of the magneto-optical signal obtained from the test zone. The sampling value Vs, which is obtained by the sample hold 64b, is temporarily stored in the memory 64c.

The magneto-optical signal, from which any unnecessary noise has been cut by the filter 64a, is inputted into the peak hold 64d to extract a maximum value Vmax and a minimum value Vmin of the magneto-optical signal detected from the test zone during the test reproduction by the peak hold 64d. The maximum value Vmax and the minimum value Vmin of the magneto-optical signal, which are obtained by the peak hold 64d, are temporarily stored in the memory 64e. However, in the first embodiment, in order to determine the optimum reproducing laser beam intensity, the magneto-optical signal from the test zone is monitored while changing the laser beam intensity as described later on. However, the maximum value Vmax and the minimum value Vmin of the magneto-optical signal, which are stored in the memory 64e, are the maximum value and the minimum value at the initial value of the laser beam intensity. In this procedure, the timing, at which each of the maximum value Vmax and the minimum value Vmin of the magneto-optical signal is stored in the memory 64e, is determined by the controller 62.

Subsequently, the maximum value Vmax of the magneto-optical signal, which is obtained by the peak hold 64d, is converted into appropriate amplitude values by the aid of the attenuator (+) 64f and the amplifier (+) 64g. Specifically, assuming that kf represents the attenuation factor of the attenuator (+) 64f and kg represents the amplification factor of the amplifier (+) 64g, the maximum value Vmax of the magneto-optical signal, which is obtained by the peak hold 64d, is converted by the attenuator (+) 64f and the amplifier (+) 64g into kfVmax and kgVmax respectively. Further, the minimum value Vmin of the magneto-optical signal, which is obtained by the peak hold 64d, is converted into appropriate amplitude values by the aid of the attenuator (−) 64h and the amplifier (−) 64i. Specifically, assuming that kh represents the attenuation factor of the attenuator (−) 64h and ki represents the amplification factor of the amplifier (−), the minimum value Vmin of the magneto-optical signal, which is obtained by the peak hold 64d, is converted by the attenuator (−) 64h and the amplifier (−) 64i into khVmin and kiVmin respectively. However, the attenuation factors kf, kh of the attenuators may be values of not more than 1, which are determined depending on, for example, the specification of the recording and reproducing apparatus and which may be set to be arbitrary values. Further, the amplification factors kg, ki of the amplifiers may be values of not less than 1, which are determined depending on, for example, the specification of the recording and reproducing apparatus and which may be set to be arbitrary values. The attenuation factors kf, kh of the attenuators may be identical values or different values. The amplification factors kg, ki of the amplifiers may be identical values or different values as well.

Subsequently, the values kfVmax, kgVmax, khVmin, and kiVmin of the magneto-optical signal converted by the attenuator (+) 64f, the amplifier (+) 64g, the attenuator (−) 64h, and the amplifier (−) 64i respectively are compared with the sampling value Vs of the magneto-optical signal obtained at the predetermined sampling interval by the sample hold 64b by using the comparators 64j, 64k, 64m, 64n respectively (the former signal will be hereinafter referred to as “reference signal” and the latter signal will be hereinafter referred to as “sample signal” as well). In the first embodiment, if the sampling value Vs of the magneto-optical signal obtained from the test zone does not satisfy kfVmax≦Vs≦kgVmax or khVmin≦Vs≦kiVmin, then the sampling value Vs is judged to be any reproduction mistake, and the miscount number is counted with the counter 64p.

The reference signal and the sample signal are compared with each other by using the comparators described above while changing the laser beam intensity to measure the miscount number at each of the laser beam intensities. The laser beam intensity, at which the miscount number is minimized, is regarded as the optimum reproducing laser beam intensity. That is, in this embodiment, the sample signal and the reference signal of the magneto-optical signal obtained from the random size maze magnetic domains formed in the test zone are compared with each other by using the comparators, and thus the frequency of the occurrence of the deficient magnetic domain expansion is counted to determine the optimum reproducing laser beam intensity.

An explanation will now be made about the relationship among the reference signal obtained from the magneto-optical signal, the sample signal, and the miscount number when the test reproduction is performed by radiating the laser beam onto the test zone while changing the laser beam intensity from the lower value to the higher value. When the laser beam intensity is sufficiently low, many magnetic domains of the random size maze magnetic domains formed in the test zone cause the expansion failure. Therefore, for example, as shown in FIG. 5A, the frequency is increased, in which the value of the sample signal is smaller than values within the predetermined range of the reference signal. That is, when sample signal and the reference signal in the magneto-optical signal waveform as shown in FIG. 5A are compared with each other by using the comparators shown in FIG. 6, then the frequency is raised to cause Vs<kfVmax or Vs<khVmin, and the miscount number is increased.

When the laser beam intensity is gradually raised, the low amplitude waveform caused by the expansion failure of the magnetic domain is decreased as shown in FIG. 5B, but the entire voltage fluctuation of the magneto-optical signal waveform is increased. Such a state increases the frequency in which the value of the sample signal obtained from the magneto-optical signal is larger than the values within the predetermined range of the reference signal. That is, when the sample signal is compared with the reference signal in the magneto-optical signal waveform as shown in FIG. 5B by using the comparators shown in FIG. 6, then the frequency is raised to cause Vs>kfVmax or Vs>khVmin, and the miscount number is increased.

When the laser beam intensity is further raised, the magnetic domain-expanding reproduction is normally caused. As shown in FIG. 5C, the expansion failure of the maze magnetic domain and the voltage fluctuation of the magneto-optical signal waveform disappear, and the magneto-optical signal waveform in which the amplitude is constant is obtained. In such a state, the value of the sample signal obtained from the magneto-optical signal is a value included in the predetermined range of the reference signal. That is, the frequency is increased, in which the sampling value Vs of the magneto-optical signal is within the range of kfVmax≦Vs≦kgVmax or khVmin≦Vs≦kiVmin. Accordingly, the miscount number is decreased.

Test Reproduction Characteristic

The change of the miscount number with respect to the laser beam intensity was measured from the magneto-optical signal obtained from the test zone by using the method for determining the reproducing laser beam intensity on the magneto-optical disk as described above to determine the optimum value of the reproducing laser beam intensity. However, the intensity of the laser beam to be radiated onto the test zone was changed from 1 mW to 2 mw by every 0.1 mW. The linear velocity of the magneto-optical disk was 4 m/s. In this case, the test reproduction was performed by radiating the laser beam onto the random size maze magnetic domains formed in the test zone (III) shown in FIG. 3. However, when the spike-shaped noise was present in the sum signal of the magneto-optical signal obtained from the test zone (III) during the test reproduction, i.e., when any defect existed in the test zone (III), then the test reproduction in the test zone (III) was stopped, and the test reproduction was performed in another test zone (III).

When the optimum laser beam intensity was determined, the maximum value Vmax and the minimum value Vmin of the magneto-optical signal, which were inputted from the peak hold 64d shown in FIG. 6 into the attenuators 64f, 64h and the amplifiers 64g, 64i, were the values to be obtained when the laser beam intensity was 1 mw (initial value). The attenuation factors kf, kh for the attenuators 64f, 64h were 50% of the input signal, and the amplification factors kg, ki of the amplifiers 64g, 64i were 120% of the input signal.

The sampling value Vs of the magneto-optical signal, which was detected at the predetermined sampling interval with the reference clock signal by the sample hold 64b shown in FIG. 6, was compared by the four comparators with the four reference signal voltages of the magneto-optical signal kfVmax, kgVmax, khVmin, and kiVmin. The sampling value Vs, which did not satisfy kfVmax≦Vs≦kgVmax or khVmin≦Vs≦kiVmin, was judged to be the mistake reproduction. The sample number was measured as the miscount number by the counter 64p. The bit error rate at each of the laser beam intensities was separately measured by using a bit error rate-measuring apparatus (not shown).

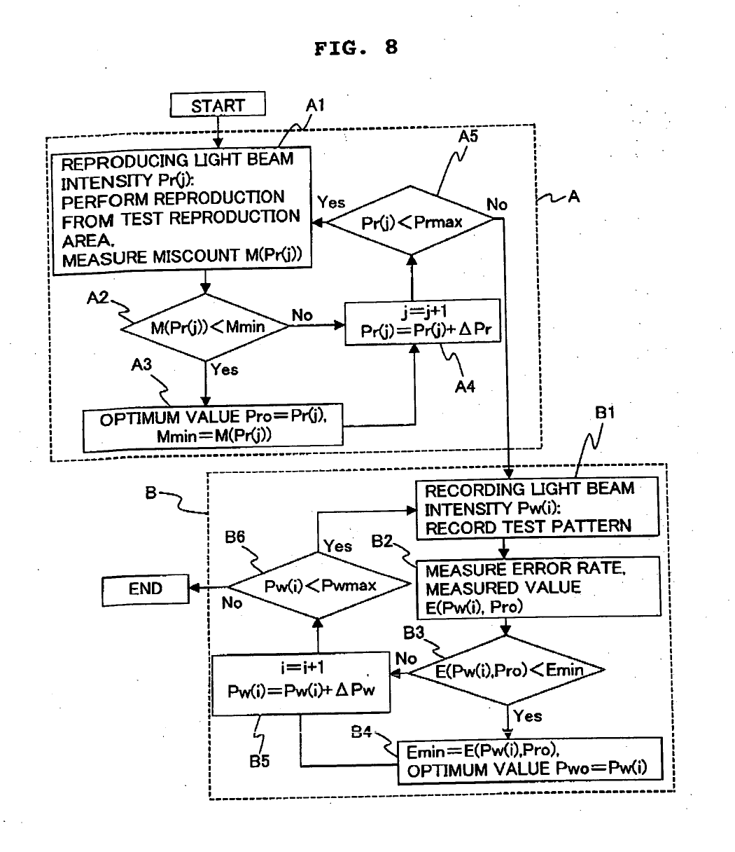

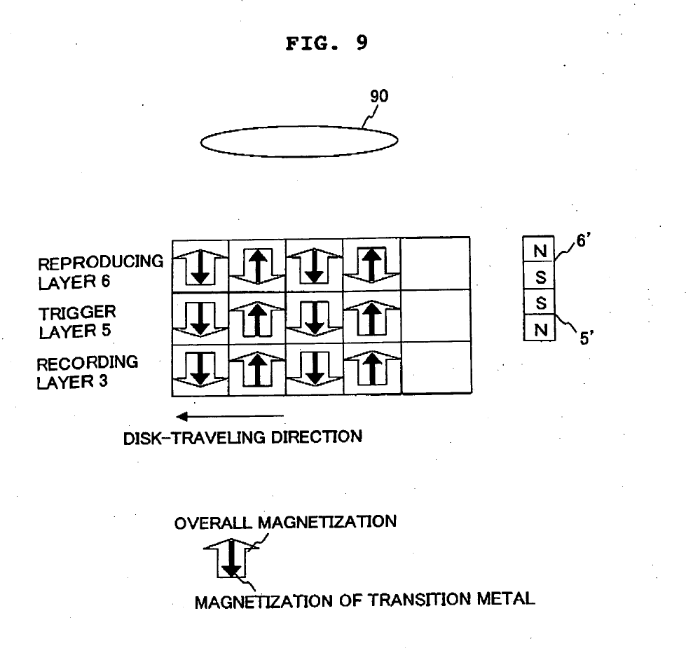

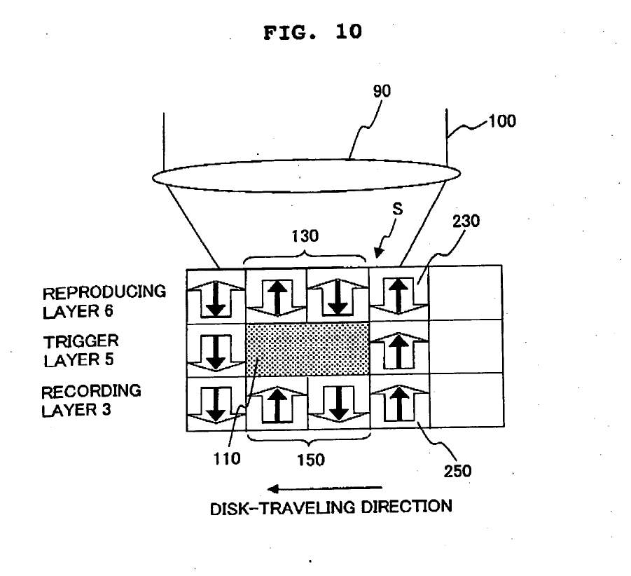

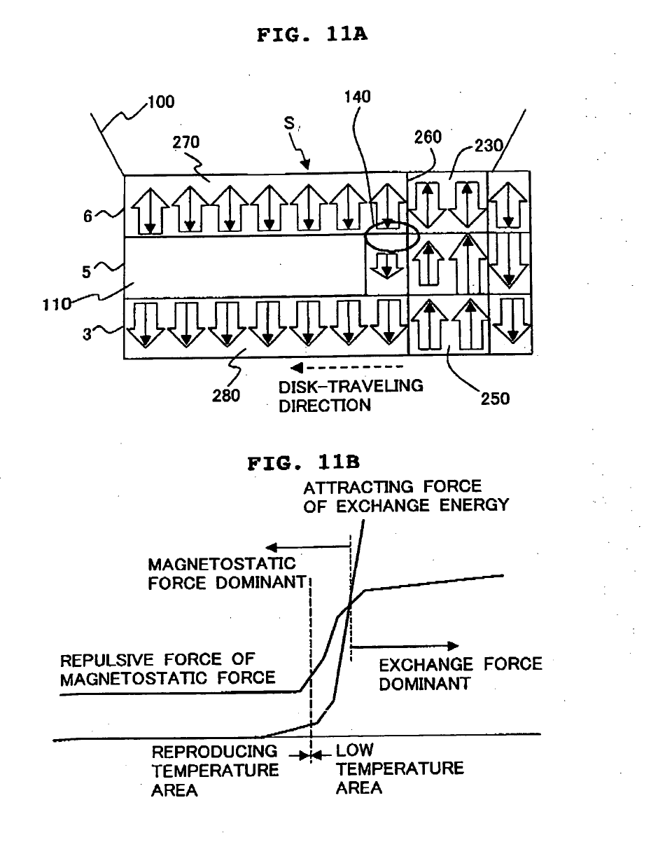

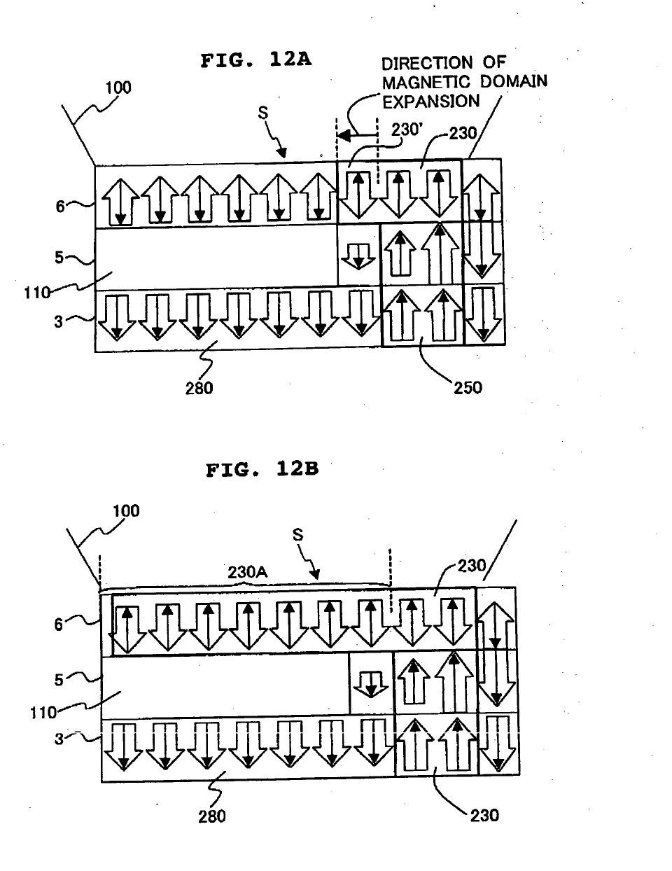

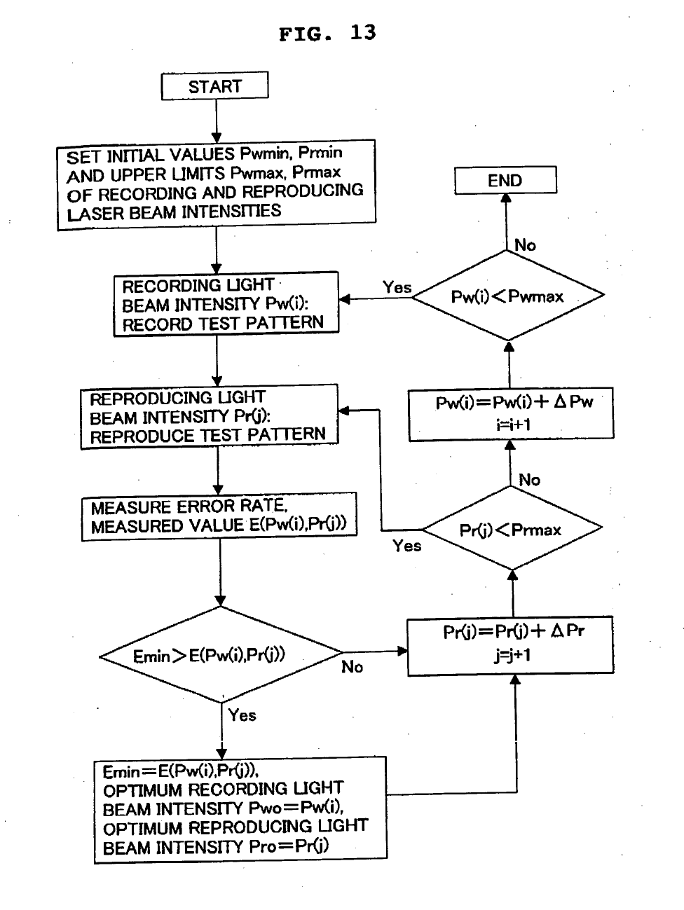

FIG. 7 shows the change of the error rate and the miscount number with respect to the laser beam intensity. FIG. 7A shows the change of the miscount number with respect to the change of the laser beam intensity radiated onto the test zone of the magneto-optical disk. FIG. 7B shows the bit error rate with respect to the change of the laser beam intensity.

As clarified from FIG. 7, the following fact has been revealed. That is, both of the miscount number and the bit error rate are changed approximately identically with respect to the laser beam intensity Pr, and both of the miscount number and the bit error rate are minimized between the laser beam intensities Pr of about 1.6 mw and 1.8 mW. That is, it has been revealed that the optimum reproducing laser beam intensity can be determined by monitoring the miscount number by comparing the sample signal and the reference signal of the magneto-optical signal obtained from the random size maze magnetic domains in the test zone by using the recording and reproducing apparatus as shown in FIG. 6.

Process for Determining Reproducing and Recording Laser Beam Intensities

Next, an explanation will be made about a series of processes for determining the optimum reproducing and recording laser beam intensities performed for the magneto-optical disk based on the Zero-Field MAMMOS manufactured in the first embodiment. FIG. 8 shows a flow chart of the method for determining the optimum reproducing laser beam intensity and the optimum recording laser beam intensity performed in the first embodiment. A broken line area A in FIG. 8 indicates a flow chart to depict the method for determining the reproducing laser beam intensity, and a broken line area B indicates a flow chart to depict the method for determining the recording laser beam intensity. The optimum recording and reproducing laser beam intensities were determined in accordance with the flow chart shown in FIG. 8 after setting the range (Pwmin to Pwmax) of the laser beam intensity to be changed in order to determine the optimum recording laser beam intensity and the range (Prmin to Prmax) of the laser beam intensity to be changed in order to determine the optimum reproducing laser beam intensity.

At first, the optimum reproducing laser beam intensity Pro is determined. A laser beam having a predetermined laser beam intensity Pr(j) is radiated onto the random size maze magnetic domains formed in the test zone of the magneto-optical disk to detect the magneto-optical signal from the test zone. The reference signal and the sample signal are compared with each other as described above to count the miscount number M(Pr(j)) at the predetermined laser beam intensity Pr(j) (Step A1).

Subsequently, the miscount number M(Pr(j)) obtained in Step A1 is compared with the minimum value Mmin of the miscount number measured before (Step A2). If the miscount number M(Pr(j)) is smaller than Mmin, there are given Mmin=M(Pr(j)), Pro=Pr(j) (Step A3). However, if the predetermined laser beam intensity Pr(j) is the initial value Prmin, then the miscount number M(Prmin) obtained in step A1 is regarded as the minimum value Mmin of the miscount number, and Pro=Prmin is given. However, the initial value Prmin of the laser beam intensity is arbitrarily established while considering the specification including, for example, the linear velocity of the magneto-optical disk.

After updating the minimum value Mmin of the miscount number and the optimum reproducing laser beam intensity Pro in Step A3, the laser beam intensity Pr(j) is changed (Pr(j)=Pr (j)+Δpr: Step A4). However, the amount of change ΔPr, which is used when the laser beam intensity Pr(j) is changed, can be set with an arbitrary value.

Subsequently, the changed laser beam intensity Pr(j) is compared with the upper limit Prmax of the laser beam intensity (Step A5). If the laser beam intensity Pr(j) is smaller than the upper limit Prmax of the laser beam intensity, the routine returns to Step A1 to repeat the operations described above. If the laser beam intensity Pr(j) is larger than the upper limit Prmax of the laser beam intensity, the routine proceeds to Step B1 to make advance to the operation for determining the recording laser beam intensity. However, the upper limit Prmax of the laser beam intensity can be set with an arbitrary value. However, if Prmax is too high, there is such a possibility that the recording layer of the test zone is heated to a temperature of not less than the Curie temperature, and the maze magnetic domains disappear. Therefore, it is necessary that Prmax is established to such a degree that the maze magnetic domains in the test zone do not disappear.

On the other hand, if the miscount number M(Pr(j)) is larger than Mmin in Step A2, then the laser beam intensity Pr(j) is changed (Step A4), and the changed laser beam intensity Pr(j) is compared with the upper limit Prmax of the laser beam intensity (Step A5). If the laser beam intensity Pr(j) is smaller than the upper limit Prmax of the laser beam intensity, the routine returns to Step A1 to repeat the operations described above. However, if the laser beam intensity Pr(j) is larger than the upper limit Prmax of the laser beam intensity, the routine proceeds to step B1 to make advance to the operation for determining the recording laser beam intensity.

The operations of steps A1 to A5 described above are repeatedly performed within the range of change of the laser beam intensity (Prmin to Prmax) to determine the optimum reproducing laser beam intensity Pro.

After determining the optimum reproducing laser beam intensity Pro in accordance with the operations described above, the optimum recording laser beam intensity Pwo is determined. However, the reproducing laser beam intensity Pro is not changed during the steps of determining the optimum recording laser beam intensity Pwo.

At first, a test pattern is recorded at a predetermined laser beam intensity Pw(i) in a test recording area (not shown) provided at a predetermined position on the magneto-optical disk (Step B1). Subsequently, the test pattern is reproduced at the reproducing laser beam intensity Pro to measure the error rate E (Pw(i), pro) (Step B2).

Subsequently, the obtained error rate E (Pw(i), Pro) is compared with the minimum value Emin of the error rate measured before (Step B3). However, if the predetermined laser beam intensity Pw(i) is the initial value Pwmin, then the error rate E (Pwmin, Pro) obtained in Step B2 is regarded as the minimum value Emin of the error rate, and Pwo=Pwmin is given. However, the initial value Pwmin of the laser beam intensity can be set with an arbitrary value while considering the specification including, for example, the linear velocity.

If the error rate E (Pw(i), Pro) is smaller than the minimum value Emin of the error rate in Step B3, there are given Emin=E(Pw(i), Pro), Pwo=Pw(i) (Step B4).

After updating the minimum value Emin of the error rate and the optimum recording laser beam intensity Pwo in Step B4, the laser beam intensity Pw(i) is changed (Pw(i)=Pw(i)+ΔPw: Step B5). However, the amount of change ΔPw, which is used when the laser beam intensity Pw(i) is changed, can be set with an arbitrary value.

Subsequently, the changed laser beam intensity Pw(i) is compared with the upper limit Pwmax of the laser beam intensity (Step B6). If the laser beam intensity PW(i) is smaller than the upper limit Pwmax of the laser beam intensity, the routine returns to Step B1. If the laser beam intensity Pw(i) is larger than the upper limit Pwmax of the laser beam intensity, the test recording comes to an end. However, the upper limit Pwmax of the laser beam intensity can be set with an arbitrary value.

On the other hand, if the error rate E (Pw(i), pro) is larger than the minimum value Emin of the error rate in Step B3, then the laser beam intensity Pw(i) is changed (Step B5), and the changed laser beam intensity Pw(i) is compared with the upper limit Pwmax of the laser beam intensity (Step B6). If the laser beam intensity Pw(i) is smaller than the upper limit Pwmax of the laser beam intensity, the routine returns to Step B1. If the laser beam intensity Pw(i) is larger than the upper limit wax of the laser beam intensity, the test recording comes to an end.

The operations of Steps B1 to B6 described above are repeatedly performed within the range of change of the layer beam intensity (Pwmin to Pwmax) to determine the optimum recording laser beam intensity Pwo.

As described above, in the method for determining the recording and reproducing laser beam intensities of the first embodiment, the random size maze magnetic domains, which are not subjected to the recording process, are used for the test zone provided to determine the reproducing laser beam intensity when the optimum reproducing laser beam intensity is determined. Therefore, it is unnecessary to newly record any test pattern for determining the reproducing laser beam intensity in the test zone. Therefore, it is possible to quickly determine the optimum reproducing laser beam intensity. As shown in FIG. 8, it is unnecessary to perform any operation (routine operation) for determining the optimum reproducing laser beam intensity again after determining the optimum recording laser beam intensity. Therefore, it is possible to more quickly determine the optimum recording and reproducing laser beam intensities. It is possible to shorten the time required until the user data and the management data are reproduced. Further, it is possible to decrease the damage on the magneto-optical recording medium based on the magnetic domain-expanding reproducing system, which would be otherwise caused by the radiation of the laser beam during the test recording and reproduction. Therefore, it is possible to further improve the reliability of the magneto-optical recording medium based on the magnetic domain-expanding reproducing system.

### Second Embodiment

In a second embodiment, the following method was used to determine the optimum reproducing light beam intensity. That is, in this method, moving average values (first moving average value and second moving average value) were determined respectively at two types of delay intervals T1, T2 with respect to the magneto-optical signal from the non-recorded area, and the reproducing light beam intensity was determined by comparing the two obtained moving average values with each other.

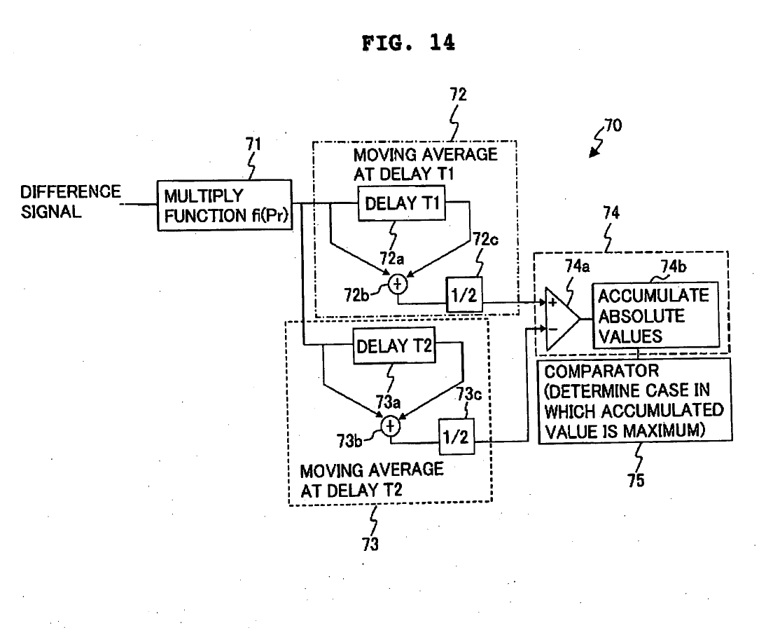

FIG. 14 shows a schematic arrangement of a recording and reproducing apparatus used in the second embodiment. FIG. 14 shows only a circuit portion corresponding to the difference signal-processing system 64 of the recording and reproducing apparatus shown in FIG. 6 used in the first embodiment. The other arrangement was the same as that of the first embodiment. In this embodiment, the magneto-optical disk based on the first surface type Zero-Field MAMMOS was used in the same manner as in the first embodiment.

As shown in FIG. 14, the difference signal-processing system 70 used in the second embodiment includes a multiplying unit 71 which multiplies the amplitude of the magneto-optical signal (difference signal) detected from the non-recorded area by a function fi(Pr) in which the value is increased as the laser beam intensity Pr is increased, a first moving average-calculating unit 72 (first circuit unit) which calculates a moving average (first moving average value) at a delay interval T1 with respect to the output signal of the multiplying unit 71, a second moving average-calculating unit 73 (second circuit unit) which calculates a moving average (second moving average value) at a delay interval T2 with respect to the output signal of the multiplying unit 71, an absolute value-calculating unit 74 (third circuit unit) which calculates the absolute value of the difference between the first and second moving average values, and a comparator 75 (discriminating unit) which determines the optimum reproducing laser beam intensity from output information from the absolute value-calculating unit 74.

The first moving average-calculating unit 72 is a two-sample moving average circuit. As shown in FIG. 14, the first moving average-calculating unit 72 includes a delay unit 72a having the delay interval T1, an adder 72b which adds the delay signal and the nondelay signal, and an average value-calculating unit 72c. On the other hand, the second moving average-calculating unit 73 is also a two-sample moving average circuit in the same manner as the first moving average-calculating unit 72. As shown in FIG. 14, the second moving average-calculating unit 73 includes a delay unit 73a having the delay interval T2, an adder 73b which adds the delay signal and the nondelay signal, and an average value-calculating unit 73c. The absolute value-calculating unit 74 includes a differential amplifier 74a which calculates the difference between the first and second moving average values, and an accumulating unit 74b which accumulates the absolute values of the differences between the first and second moving average values. In the second embodiment, the optimum reproducing laser beam intensity is determined on the basis of the accumulated value of the absolute values of the differences between the first and second moving average values as described later on.

In the second embodiment, the function fi(Pr), by which the difference signal is multiplied in the multiplying unit 71, was fi(Pr)=Pr. In the second embodiment, the delay interval T1=1T₀=120 nm was given, and the delay interval T2=3T₀ was given. In the second embodiment, the channel bit length in the modulation system to be used during the recording of user information was T₀. That is, in the second embodiment, the delay interval T1 was equal to the channel bit length. The number of accumulated samples was 1,500 samples for both of the delay intervals T1, T2.

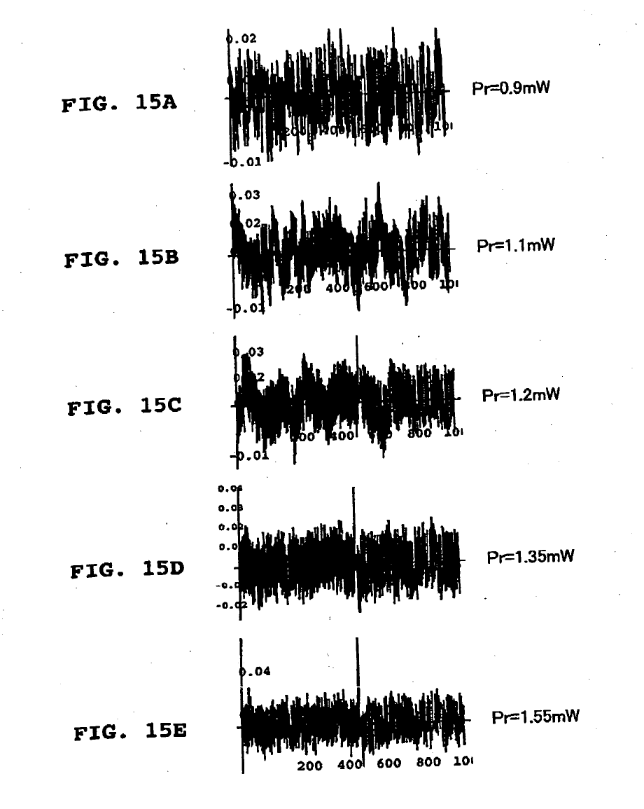

An explanation will be made with reference to FIG. 14 about the method for determining the optimum reproducing laser beam intensity in the second embodiment. At first, a laser beam having a predetermined laser beam intensity is radiated onto the non-recorded area (test zone) of the magneto-optical recording medium, and the magneto-optical signal from the test zone is detected by the optical head to output the difference signal of the magneto-optical signal. Subsequently, the outputted difference signal is inputted into the multiplying unit 71, and the amplitude of the difference signal is multiplied by the function fi(Pr). Accordingly, even when the amplitude of the magneto-optical signal itself is lowered when the laser beam intensity Pr is extremely large, it is possible to control the variation of the amplitude to be inputted into the calculation of the moving average. FIG. 15 shows signal waveforms obtained when the difference signal of the magneto-optical signal from the test zone is multiplied by the function fi(Pr). FIGS. 15A to 15E indicate the signal waveforms obtained when the laser beam intensity was changed from 0.9 to 1.55 mW. Subsequently, as shown in FIG. 14, the output signal from the multiplying unit 71 is inputted into the first moving average-calculating unit 72 and the second moving average-calculating unit 73.

In the first moving average-calculating unit 72, the moving average (first moving average value) is determined at the delay interval T1 with respect to the output signal of the multiplying unit 71. Specifically, as shown in FIG. 14, the output signal of the multiplying unit 71 is delayed by the time T1 by the delay unit 72a, and then the delay signal and the nondelay signal (output signal of the multiplying unit 71) are added by the adder 72b. Subsequently, the added value is multiplied by ½ by the average value-calculating unit 72c to determine the first moving average value at the delay interval T1 with respect to the output signal of the multiplying unit 71. On the other hand, in the second moving average-calculating unit 73, the second moving average value is determined at the delay interval T2 with respect to the output signal of the multiplying unit 71 in accordance with the same operation as that performed in the first moving average-calculating unit 72.

The first moving average value and the second moving average value with respect to the output signal of the multiplying unit 71 determined by the operation as described above are inputted into the differential amplifier 74a of the absolute value-calculating unit 74 to determine the difference between the first moving average value and the second moving average value. Subsequently, the difference between the first moving average value and the second moving average value, which is outputted from the differential amplifier 74a, is inputted into the accumulating unit 74b to accumulate a predetermined sample number (1,500 samples in the second embodiment) of the absolute values of the differences between the first moving average values and the second moving average values. The accumulated absolute values are inputted into the comparator 75. The operation as described above is repeated while changing the laser beam intensity. Subsequently, the optimum reproducing laser beam intensity is determined from the relationship between the laser beam intensity and the accumulated value of the absolute values of the differences between the first moving average values and the second moving average values. In the second embodiment, the laser beam intensity, at which the accumulated value of the absolute value of the difference between the first moving average value and the second moving average value was maximum, was regarded as the optimum reproducing light beam intensity. This is based on the following basis.

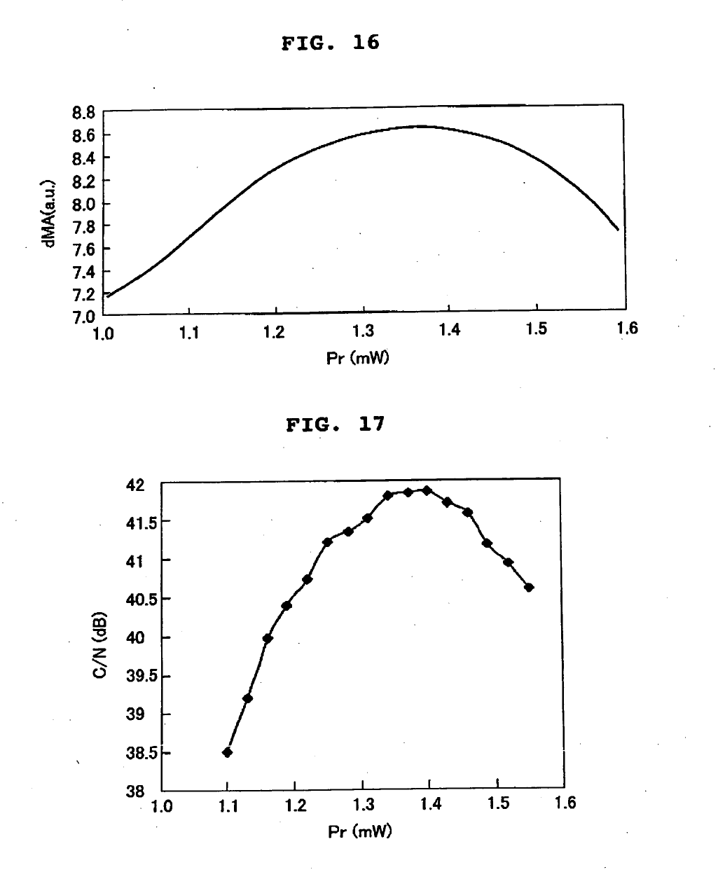

When the relationship between the laser beam intensity Pr and the accumulated value dMA of the absolute value of the difference between the first and second moving average values was determined by using the method for determining the reproducing light beam intensity in the second embodiment, a characteristic as shown in FIG. 16 was obtained. When the dependency of C/N (signal-to-noise ratio) on the laser beam intensity Pr was measured for the magneto-optical recording medium used for the measurement shown in FIG. 16, a characteristic as shown in FIG. 17 was obtained. As clarified from the characteristics shown in FIGS. 16 and 17, the following fact has been revealed. That is, both of the accumulated value dMA and C/N are changed similarly with respect to the laser beam intensity. Pr, and the laser beam intensity Pr, at which the accumulated value dMA is maximized, is approximately the same as the laser beam intensity Pr at which C/N is maximized. That is, the following fact has been revealed. The dependency of the accumulated value dMA on the laser beam intensity Pr is strongly correlated to the dependency of C/N on the laser beam intensity Pr. When the laser beam intensity Pr, at which the accumulated value dMA of the absolute value of the difference between the first and second moving average values is maximized, is selected in accordance with FIG. 16, it is possible to determine the Optimum reproducing laser beam intensity.

As described above, in the method for determining the recording and reproducing laser beam intensities in the second embodiment, when the optimum reproducing laser beam intensity is determined, the random size maze magnetic domains, in which the recording process is not performed, are used for the test zone provided in order to determine the reproducing laser beam intensity, in the same manner as in the first embodiment. Therefore, it is unnecessary to newly record, in the test zone, any test pattern in order to determine the reproducing laser beam intensity. Therefore, it is possible to quickly determine the optimum reproducing laser beam intensity. Further, it is possible to decrease the damage on the magneto-optical recording medium based on the magnetic domain-expanding reproducing system, which would be otherwise caused by the radiation of the laser beam during the test recording and reproduction. Therefore, it is possible to further improve the reliability of the magneto-optical recording medium based on the magnetic domain-expanding reproducing system. Further, the method for determining the reproducing laser beam intensity of the second embodiment is simpler than the method for determining the reproducing light beam intensity of the first embodiment. Therefore, it is possible to determine the reproducing laser beam intensity more easily.

The description has been made in the first and second embodiments described above about the method for determining the reproducing laser beam intensity for the magneto-optical disk based on the first surface type Zero-Field MAMMOS. However, the present invention is not limited thereto. Even in the case of a magneto-optical disk based on the substrate incident type Zero-Field MAMMOS in which the laser beam is radiated onto the magnetic layer through the substrate, when the maze random size magnetic domains, which are as shown in the area 11 in FIG. 1, are formed in the magnetic film after forming the magnetic film, the reproducing laser beam intensity can be determined in accordance with the same or equivalent method.

The description has been made in the first and second embodiments described above about the examples in which the method for determining the reproducing laser beam intensity is applied to the magneto-optical disk based on the CLV control. However, the present invention is not limited thereto. The present invention may be also applied to the magneto-optical disk based on the CAV control.

In the first embodiment described above, the optimum reproducing laser beam intensity is determined by counting the miscount number by comparing the sample signal and the reference signal of the magneto-optical signal obtained from the random size maze magnetic domains in the test zone. However, the present invention is not limited thereto. For example, sample signals, which are included in sample signals of the magneto-optical signal obtained from the random size maze magnetic domains in the test zone at the predetermined sampling interval and which has been subjected to the normal magnetic domain expansion, may be counted. The laser beam intensity, at which the count number is maximized, may be regarded as the optimum reproducing light beam intensity.

The description has been made in the first and second embodiments described above about the magneto-optical disk having the linear velocity of 4 m/s. However, the present invention is not limited thereto. The method for determining the reproducing laser beam intensity of the present invention can be applied at an arbitrary linear velocity.

The description has been made in the first and second embodiments described above principally about the examples of the method for determining the optimum reproducing light beam intensity by detecting the magneto-optical signal from the test zone (III) shown in FIG. 3. However, the present invention is not limited thereto. The same or equivalent result is obtained even when the optimum reproducing laser beam intensity is determined by radiating the laser beam onto the test zones (I) and (II) shown in FIG. 3.

The description has been made in the first and second embodiments described above about the examples in which the method for determining the reproducing laser power of the present invention is applied to the magneto-optical disk based on the Zero-Field MAMMOS. However, the present invention is not limited thereto. The present invention is also applicable, for example, to magneto-optical disks of the domain wall displacement type such as DWDD and MAMMOS of the type in which any external magnetic field is applied during the reproduction.

In the second embodiment described above, the number of accumulated samples for the first moving average value is the same as the number of accumulated samples for the second moving average value. However, the present invention is not limited thereto. The number of accumulated samples may differ. The number of samples for each of the moving average values may be optimized depending on the medium characteristic of the magneto-optical recording medium. In particular, it is preferable to effect the optimization corresponding to the size distribution of the random size maze magnetic domains formed on the magneto-optical recording medium.

According to the method for determining the reproducing laser beam intensity of the present invention, the laser beam is radiated onto the non-recorded area having the random size maze magnetic domains not subjected to the recording process, and the optimum reproducing laser beam intensity is determined on the basis of the magneto-optical signal obtained from the non-recorded area. Therefore, it is unnecessary to newly record any test pattern in the test zone in order to determine the reproducing laser beam intensity. Therefore, this method is preferred to determine, accurately in a shorter period of time, the optimum reproducing laser beam intensity in order to reproduce the user data and/or the various management data on the magneto-optical recording medium based on the magnetic amplifying magneto-optical transfer system (MAMMOS).

According to the method for determining the reproducing laser beam intensity of the present invention, it is possible to provide the method for setting the reproducing laser beam intensity in which the various characteristic margins of the magneto-optical recording medium based on the magnetic amplifying magneto-optical transfer system are spread or widened, and the reliability of the medium itself is improved.

1. A method for determining a reproducing light beam intensity for a magneto-optical recording medium which is provided with a recording layer for recording information as magnetic domains, a reproducing layer for magnetically transferring the magnetic domains of the recording layer and an intermediate layer provided between the recording layer and the reproducing layer, and in which the magnetic domains magnetically transferred to the reproducing layer are expanded by being irradiated with a reproducing light beam to amplify and reproduce a magneto-optical signal, the method for determining the reproducing light beam intensity comprising:
detecting the magneto-optical signal by radiating the light beam onto a non-recorded area of the magneto-optical recording medium while changing a light intensity; and
determining an optimum reproducing light beam intensity on the basis of magneto-optical signals detected from the non-recorded area at respective light intensities.

2. The method for determining the reproducing light beam intensity according to claim 1, wherein the non-recorded area has magnetic domains of random sizes.

3. The method for determining the reproducing light beam intensity according to claim 1, wherein the non-recorded area is a test reproduction area which is previously provided on the magneto-optical recording medium and which is prohibited from writing.

4. The method for determining the reproducing light beam intensity according to claim 1, wherein the determination of the optimum reproducing light beam intensity includes measuring a peak value of the magneto-optical signal from the non-recorded area, sampling the magneto-optical signal obtained from the non-recorded area at a predetermined sampling interval, and comparing the peak value of the magneto-optical signal with a sampling value of the magneto-optical signal to determine the reproducing light beam intensity.

5. The method for determining the reproducing light beam intensity according to claim 1, wherein the determination of the optimum reproducing light beam intensity includes determining a first moving average value at a delay interval T1 with respect to the magneto-optical signal from the non-recorded area, determining a second moving average value at a delay interval T2 with respect to the magneto-optical signal from the non-recorded area, and comparing the first moving average value with the second moving average value to determine the reproducing light beam intensity.

6. The method for determining the reproducing light beam intensity according to claim 1, wherein the determination of the optimum reproducing light beam intensity comprises determining a first moving average value at a delay interval T1 with respect to the magneto-optical signal from the non-recorded area, determining a second moving average value at a delay interval T2 with respect to the magneto-optical signal from the non-recorded area, and determining the reproducing light beam intensity from an absolute value of a difference between the first moving average value and the second moving average value.

7. The method for determining the reproducing light beam intensity according to claim 1, wherein the determination of the optimum reproducing light beam intensity includes multiplying an amplitude of the magneto-optical signal from the non-recorded area by a function fi(Pr) in which a value is increased as the light intensity pr is increased, determining a first moving average value at a delay interval T1 with respect to a signal obtained by multiplying the function fi(Pr), determining a second moving average value at a delay interval T2 with respect to a signal obtained by multiplying the function fi(Pr), determining an accumulated value of an absolute value of a difference between the first moving average value and the second moving average value, and determining the reproducing light beam intensity from the accumulated value.

8. The method for determining the reproducing light beam intensity according to claim 5, wherein any one of the delay interval T1 and the delay interval T2 is equal to a channel bit length in a modulation system to be used when user information is recorded.

9. The method for determining the reproducing light beam intensity according to claim 1, wherein the method for determining the light beam intensity is executed before reproducing user information on the magneto-optical recording medium on which the user information is recorded.

10. A method for determining a recording light beam intensity, further comprising determining the recording light beam intensity on the basis of the reproducing light beam intensity obtained by the method for determining the reproducing light beam intensity as defined in claim 1.

11. A magneto-optical recording medium based on a magnetic domain-expanding reproducing system, comprising the non-recorded area which is used to determine the optimum reproducing light beam intensity in accordance with the method for determining the reproducing light beam intensity as defined in claim 1.

12. The magneto-optical recording medium according to claim 11, wherein the magneto-optical recording medium has a plurality of zones, and each of the zones is provided with the non-recorded area.

13. The magneto-optical recording medium according to claim 11, wherein the reproducing light beam is radiated onto the reproducing layer, the intermediate layer, and the recording layer without passing through a substrate when information is recorded and reproduced.

14. A recording and reproducing apparatus for a magneto-optical recording medium which is provided with a recording layer for recording information as magnetic domains, a reproducing layer for magnetically transferring the magnetic domains of the recording layer and an intermediate layer provided between the recording layer and the reproducing layer, and in which the magnetic domains magnetically transferred to the reproducing layer are expanded by being irradiated with a reproducing light beam to amplify and reproduce a magneto-optical signal, the recording and reproducing apparatus comprising:
an optical head;
a multiplying unit which multiplies, by a predetermined function, an amplitude of a magneto-optical signal from a non-recorded area of the magneto-optical recording medium detected by the optical head;
a first circuit unit which calculates a first moving average value at a delay interval T1 with respect to an output signal of the multiplying unit;
a second circuit unit which calculates a second moving average value at a delay interval T2 with respect to the output signal of the multiplying unit;
a third circuit unit which calculates an absolute value of a difference between the first moving average value and the second moving average value; and
a discriminating unit which selects an optimum reproducing light beam intensity on the basis of output information of the third circuit unit.
